(19) United States
(12) Patent Application Publication
(10) Pub. No.: US 2014/0159608 A1
(43) Pub. Date: Jun. 12, 2014

(54) DRIVER CIRCUIT FOR DIMMABLE SOLID STATE LIGHT SOURCES WITH FILTERING AND PROTECTIVE ISOLATION

(71) Applicants: Victor M. Simi, Lexington, KY (US); Tracy S. Woo, Cambridge, MA (US); Khounthavy Nai Phasay, Cambridge, MA (US)

(72) Inventors: Victor M. Simi, Lexington, KY (US); Tracy S. Woo, Cambridge, MA (US); Khounthavy Nai Phasay, Cambridge, MA (US)

(73) Assignee: OSRAM SYLVANIA INC., Danvers, MA (US)

(21) Appl. No.: 14/088,336

(22) Filed: Nov. 22, 2013

Related U.S. Application Data
(63) Continuation-in-part of application No. 13/776,604, filed on Feb. 25, 2013, now abandoned.
Application No. 13/776,604 is a continuation of application No. 12/616,301, filed on Nov. 11, 2009, now Pat. No. 8,384,295.
Application No. 12/616,301 is a continuation-in-part of application No. 13/222,465, filed on Aug. 31, 2011.
(60) Provisional application No. 61/814,330, filed on Apr. 21, 2013.

(51) Int. Cl. H05B 33/08

(52) U.S. Cl. CPC H05B 33/0815
USPC 315/205

(57) ABSTRACT

A driver circuit for a lamp assembly including one or more solid state light sources is provided. The driver circuit includes filtering and power factor correction with protective isolation. The driver circuit includes a transformer with electrically isolated windings and a power factor correction circuit that receives no feedback from a secondary winding of the transformer.

### CROSS-REFERENCE TO RELATED APPLICATIONS

The present application is a continuation-in-part of U.S. patent application Ser. No. 13/776,604, filed Feb. 25, 2013 and entitled “BALLAST CIRCUIT FOR LED-BASED LAMP INCLUDING POWER FACTOR CORRECTION WITH PROTECTIVE ISOLATION”, which is continuation of, and claims priority of, U.S. patent application Ser. No. 12/616,301, filed Nov. 11, 2009 and entitled “BALLAST CIRCUIT FOR LED-BASED LAMP INCLUDING POWER FACTOR CORRECTION WITH PROTECTIVE ISOLATION”, now U.S. Pat. No. 8,384,295. The present application is also a continuation-in-part of U.S. patent application Ser. No. 13/222,465, filed Aug. 31, 2011 and entitled “DRIVER CIRCUIT FOR DIMMABLE SOLID STATE LIGHT SOURCE”. The present application also claims priority of U.S. Provisional Patent Application No. 61/814,330, filed Apr. 21, 2013 and entitled “ELECTRONIC DRIVER AND COOLING THEREOF”. The entire contents of all of these are hereby incorporated by reference.

### TECHNICAL FIELD

The present application relates to a ballast circuit for a light emitting diode (LED)-based lamp including power factor correction with protective isolation. The present invention also relates to lighting, and more specifically, to driver circuitry for solid state light source(s).

### BACKGROUND

The development of high-brightness LEDs has led to use of such devices in various lighting fixtures. In general, an LED-based lamp operates in a fundamentally different way than an incandescent, or gas discharge lamp, and therefore may not be connectable to existing lighting fixtures designed for those types of lamps. A ballast circuit may be used, however, to allow use of an LED-based lamp as a retro-fit for existing lighting fixtures.

The ballast circuitry for an LED-based lamp generally converts an alternating current (AC) input, such as a 120V/60 Hz line input or input from a dimmer switch, to a stable direct current (DC) voltage used for driving the LED-based lamp. Such circuitry may incorporate a rectifier for receiving the AC input and a DC-DC converter circuit. The DC-DC converter circuit may receive an unregulated DC output from the rectifier and provide a stable, regulated DC output to the LED-based lamp.

A variety of DC-DC converter configurations are well-known in the art. Certain types of known DC-DC converter configurations, such as buck converters, boost converters, buck-boost converters, etc., are generally categorized as switching regulators. These devices include a switch, e.g. a transistor, which is selectively operated to allow energy to be stored in an energy storage device, e.g. an inductor, and then transferred to one or more filter capacitors. The filter capacitor(s) provide a relatively smooth DC output voltage to the load and provide essentially continuous energy to the load between energy storage cycles.

One issue with such switching regulator configurations is that there may be no protective isolation between the unregulated DC voltage and the regulated DC output voltage. In some configurations, the unregulated DC voltage may be 400 Volts or more. The unregulated DC voltage can be dangerous if inadvertently applied to the load.

To provide protective isolation, therefore, a transformer-based switching regulator, such as a known “flyback” converter, may be used. In a transformer-based switching regulator, the primary side of the transformer may be coupled to the unregulated DC voltage. The regulated DC output voltage is provided at the secondary side of the transformer, which is electrically isolated from the primary side of the transformer. The transformer may thus provide protective isolation of the DC output from the unregulated DC voltage.

Another issue with switching regulator configurations is that they involve a pulsed current draw from the AC power source in a manner that results in less than optimum power factor. The power factor of a system is defined as the ratio of the real power flowing to the load to the apparent power, and is a number between 0 and 1 (or expressed as a percentage, e.g. 0.5 pf=50% pf). Real power is the actual power drawn by the load. Apparent power is the product of the current and voltage applied to the load.

For systems with purely resistive loads, the voltage and current waveforms are in phase, changing polarity at the same instant in each cycle. Such systems have a power factor of 1.0, which is referred to as “unity power factor.” Where reactive loads are present, such as with loads including capacitors, inductors, or transformers, energy storage in the load results in a time difference between the current and voltage waveforms. This stored energy returns to the source and is not available to do work at the load. Systems with reactive loads often have less than unity power factor. A circuit with a low power factor will use higher currents to transfer a given quantity of real power than a circuit with a high power factor.

To provide improved power factor, some lamp ballast circuit configurations are provided with a power factor correction circuit. The power factor correction circuit may be used, for example, as a controller for controlling operation of the transistor switch in a DC-DC converter configuration such as a “flyback” converter. In such a configuration, a power factor controller may monitor the rectified AC voltage, the current drawn by the load, and the output voltage to the load, and provide an output control signal to the transistor to switch current to the load having a waveform that substantially matches and is in phase with the rectified AC voltage.

### SUMMARY

In conventional lamp ballast configurations including a transformer-based switching regulator and power factor controller circuits, such as those described above, complete isolation between the primary and secondary sides of the transformer has been sacrificed to provide a feedback to the power factor controller or, for example, to establish a common ground path for the circuit. This, however, increases the potential risk associated with inadvertent application of the unregulated DC voltage to the load. In addition, when such configurations are used with conventional phase-control dimming circuits, the transient response time associated with the power controller circuit may not be sufficient to establish acceptable dimming of the lamp without perceptible flicker.

Consistent with the present disclosure, therefore, there is provided an LED ballast circuit and system that converts AC input such as a 120V/60 Hz input into a current source for an LED-based light source. The circuit includes complete transformer isolation and may use a single integrated circuit power factor controller to produce a pulsating DC output current that is amplitude modulated by the power factor controller at, for example, 120 Hertz. The resulting input power factor may be set very close to unity. The total harmonic distortion at the input may be very low, and any conducted EMI may be mitigated by the variable frequency switching technique. Additionally, the size of the transformer may be relatively small because of the high frequency operation and the switching topology, and the controller bias network and feedback configuration may eliminate the need for large electrolytic capacitors, or multiple capacitors, for dimming applications. The circuit may thus provide a very high power factor, high efficiency and small size that will work with dimmer switches, such as a reverse phase FET dimmer, without flicker at small conduction angles.

A typical switching regulator configuration found in a solid state light source driver suffers from a variety of issues. One issue is that there may be no protective isolation between the unregulated DC voltage and the regulated DC output voltage. In some configurations, the unregulated DC voltage may be 400 Volts or more. The unregulated DC voltage may be dangerous (i.e., destructive), if inadvertently applied to the load. To provide protective isolation, therefore, a transformer-based switching regulator, such as a known “flyback” converter, may be used. In a transformer-based switching regulator, the primary side of the transformer may be coupled to the unregulated DC voltage. The regulated DC output voltage is provided at the secondary side of the transformer, which is electrically isolated from the primary side of the transformer. The transformer may thus provide protective isolation of the DC output from the unregulated DC voltage.

Another issue with a typical switching regulator configuration is that it involves a pulsed current draw from the AC power source in a manner that results in a less than optimum power factor. The power factor of a system is defined as the ratio of the real power flowing to the load to the apparent power, and is a number between 0 and 1 (or expressed as a percentage, e.g. 0.5 pf=50% pf). Real power is the actual power drawn by the load. Apparent power is the product of the current and voltage applied to the load. For systems with purely resistive loads, the voltage and current waveforms are in phase, changing polarity at the same instant in each cycle. Such systems have a power factor of 1.0, which is referred to as “unity power factor.” Where reactive loads are present, such as with loads including capacitors, inductors, or transformers, energy storage in the load results in a time difference between the current and voltage waveforms. This stored energy returns to the source and is not available to do work at the load. Systems with reactive loads often have less than unity power factor. A circuit with a low power factor will use higher currents to transfer a given quantity of real power than a circuit with a high power factor.

To provide improved power factor, some solid state light source driver circuit configurations are provided with a power factor controller circuit. The power factor controller circuit may be used, for example, as a controller for controlling operation of the transistor switch in a DC-DC converter configuration such as a flyback converter. In such a configuration, a power factor controller may monitor the rectified AC voltage, the current drawn by the load, and the output voltage to the load, and provide an output control signal to the transistor to switch current to the load having a waveform that substantially matches and is in phase with the rectified AC voltage.

Yet another issue with a typical switching regulator configuration is that it may introduce harmonic distortion in the form of ripples on the voltage signal returned to the AC power source. These ripples occur at harmonics of the AC line frequency. When these ripples are fed back into the power line, some of the ripples, especially those at third order harmonics of the AC line frequency, may build up voltage levels on the neutral line of power-company-owned three-phase transformers and may damage power-company-owned equipment. Reducing the total harmonic distortion (THD) is thus becoming increasingly important as solid state light sources are more widely used. Indeed, reducing THD and increasing power factor may be important in complying with the Energy Solutions LED Accelerator Program (LEDA), which sets product qualification requirements for certain solid state light source-based lamps.

Unfortunately, THD can be exacerbated in solid state light source that includes a dimming control circuit. The dimming control circuit may receive line voltage, e.g. from a 120 VAC/60 Hz source, and provide a modified output signal to the rectifier for the purpose of controlling the illumination level of the solid state light source. In some configurations, the dimming control circuit may be a circuit known as a “phase control” dimmer or a “phase-cut” dimmer. In a phase control dimmer, a fraction of the input voltage sine-wave is cut in each period of the waveform either at the leading or trailing edge of the waveform. During the cut-time interval or “dead time” when the voltage is cut, the output of the phase control dimmer may be substantially zero. The residual time interval where the voltage differs from zero is known as the “dimmer conduction time.” Both the dimmer conduction time and the dead time are variable, but the time period of the input voltage waveform is constant, e.g. 1/60 second in the United States. As used herein, the “dimmer setting” refers to the ratio of the dimmer conduction time to the time period of the input waveform. The dimmer setting of a phase control dimmer is controllable by a user. In some configurations, the dimmer setting may be varied from about 0.78 to about 0.25. During the dead time at the lowest dimmer setting of the dimmer, the supply voltage to the power factor controller circuit may diminish to a level below its nominal operating range. This may impact performance of the power factor controller circuit, and can lead to an increase in THD as well as reduced power factor.

Embodiments of the present invention therefore provide a solid state light source driver circuit and methods that convert AC input, such as a 120V/60 Hz input, into a current source for an solid state light source. The driver circuit includes overvoltage protection with optically isolated feedback from the output stage to the power factor controller. The driver circuit may use a single integrated circuit power factor controller to produce a pulsating DC output current that is amplitude modulated by the power factor controller at, for example, 120 hertz. The resulting input power factor may be set very close to unity. The total harmonic distortion at the input may be very low, and any conducted EMI may be mitigated by the variable frequency switching technique as well as the EMI filter components. The supply voltage circuit may eliminate the need for large electrolytic capacitors, or Zener diodes, for dimming applications. The circuit may thus provide a very high power factor, high efficiency, and small size that will work with dimmer switches, including both forward phase and reverse phase dimmers, without flicker in the solid state light source.

In an embodiment there is provided a ballast circuit to drive a light emitting diode (LED)-based light source. The ballast circuit includes a rectifier circuit configured to receive an AC input voltage and provide an unregulated DC voltage, and a transformer. The transformer has a primary winding coupled to the rectifier circuit, at least one secondary winding configured to be coupled to the LED-based light source, and a feedback winding, the secondary winding being electrically isolated from the primary winding and the feedback winding with no electrical path between the primary winding and the secondary winding or the feedback winding and the secondary winding. The ballast circuit also includes a switch, the switch being configured to close to couple a portion of the unregulated DC voltage across the primary winding and the switch being configured to open to transfer energy from the primary winding to the secondary winding to provide a DC output voltage to drive the LED-based light source. The ballast circuit also includes a power factor correction circuit configured to control the switch in response to a first signal representative of current through the primary winding, a second signal representative of current through the feedback winding, and a third signal representative of the unregulated DC voltage, with no feedback signal coupled from the secondary winding to the controller.

In a related embodiment, the ballast circuit may further include a switched bias circuit, the switched bias circuit including a bias circuit switch configured to close when the switch is open to provide a supply voltage to the power factor correction circuit. In a further related embodiment, the switched bias circuit may be coupled to the feedback winding, and the bias circuit switch may be configured to close in response to current through the feedback winding.

In another related embodiment, the ballast circuit may further include an over-voltage protection circuit coupled to the power factor correction circuit to disable the power factor controller circuit when a voltage at the transformer exceeds a predetermined level. In a further related embodiment, the over-voltage protection circuit may include a Zener diode coupled to the feedback winding, whereby a breakdown voltage of the Zener diode is exceeded when the voltage at the transformer exceeds the predetermined level thereby disabling the power factor controller circuit. In another further related embodiment, the over-voltage protection circuit may include an over-voltage protection switch configured to close when the voltage at the transformer exceeds the predetermined level thereby disabling the power factor controller circuit.

In still another related embodiment, the power factor correction circuit may include an integrated circuit power factor controller configured to receive the first signal, the second signal, and the third signal and to provide an output to control the switch. In yet another related embodiment, the AC input signal may be a 120V AC signal.

In another embodiment, there is provided an LED-based lamp assembly. The LED-based lamp assembly includes a lamp housing, a light source disposed within the lamp housing, and a ballast disposed within the lamp housing. The ballast includes: a rectifier circuit configured to receive an AC input voltage and provide an unregulated DC voltage; a transformer having a primary winding coupled to the rectifier circuit, at least one secondary winding coupled to the LED-based light source, and a feedback winding, the secondary winding being electrically isolated from the primary winding and the feedback winding with no electrical path between the primary winding and the secondary winding or the feedback winding and the secondary winding; a switch, the switch being configured to close to couple a portion of the unregulated DC voltage across the primary winding and the switch being configured to open to transfer energy from the primary winding to the secondary winding to provide a DC output voltage to drive the LED-based light source; and a power factor correction circuit configured to control the switch in response to a first signal representative of current through the primary winding, a second signal representative of current through the feedback winding and a third signal representative of the unregulated DC voltage, with no feedback signal coupled from the secondary winding to the controller.

In yet another embodiment, there is provided a method of driving an LED-based light source. The method includes: receiving an AC input signal, and converting the AC input signal into a regulated DC output using a ballast circuit. The ballast circuit includes: a transformer having a primary winding, a secondary winding and a feedback winding, the secondary winding being electrically isolated from the primary winding and the feedback winding with no electrical path between the primary winding and the secondary winding or the feedback winding and the secondary winding, and a power factor correction circuit receiving no feedback signal coupled from the secondary winding. The method also includes coupling the regulated DC output to the LED-based light source.

In an embodiment, there is provided a driver circuit for a light emitting diode (LED)-based light source. The driver circuit includes: a rectifier circuit configured to receive an AC input voltage and provide an unregulated DC voltage; a transformer having a primary winding coupled to the rectifier circuit, at least one secondary winding configured to be coupled to the LED-based light source, and a feedback winding; a switch, the switch being configured to close for coupling a portion of the unregulated DC voltage across the primary winding and the switch being configured to open to transfer energy from the primary winding to the secondary winding to provide a DC output voltage to drive the LED-based light source; a power factor controller circuit configured to provide an output signal to control the switch; and a supply voltage circuit coupled to the feedback winding and configured to provide a supply voltage to the power factor controller circuit at the high end of a nominal supply voltage operating range of the power factor controller circuit.

In a related embodiment, the supply voltage circuit may include: a first energy storage circuit coupled to the rectifier circuit to receive the unregulated DC voltage, wherein the first energy storage circuit may include a first energy storage element coupled to the power factor controller circuit to provide the supply voltage; and a second energy storage circuit coupled to the feedback winding, wherein the second energy storage circuit may include a second energy storage element; wherein current from the unregulated DC voltage may charge the first energy storage element and wherein current through the feedback winding may charge the second energy storage element and the first energy storage element.

In a further related embodiment, the first energy storage element may include a first capacitor and the second energy storage element may include a second capacitor. In a further related embodiment, the first capacitor and the second capacitor may be coupled in parallel.

In another related embodiment, the driver circuit may further include: an output; and an open circuit protection circuit coupled to the secondary winding and to the power factor controller circuit, the open circuit protection circuit configured to disable the power factor controller circuit when an open circuit occurs at the output. In a further related embodiment, the open circuit protection circuit may optically couple the secondary winding to the power factor controller circuit. In another further related embodiment, the open circuit protection circuit may include an optically isolated switch coupled to the power factor controller circuit and optically coupled to the secondary winding, the switch being configured to close when the open circuit occurs at the output.

In yet another related embodiment, the secondary winding may be capacitively coupled to the feedback winding, the capacitive coupling to provide electromagnetic interference (EMI) filtering.

In another embodiment, there is provided a lamp assembly. The lamp assembly includes: a lamp housing; an LED-based light source disposed within the lamp housing; and a driver disposed within the lamp housing. The driver includes: a rectifier circuit configured to receive an AC input voltage and provide an unregulated DC voltage; a transformer having a primary winding coupled to the rectifier circuit, at least one secondary winding configured to be coupled to the LED-based light source, and a feedback winding; a switch, the switch being configured to close for coupling a portion of the unregulated DC voltage across the primary winding and the switch being configured to open to transfer energy from the primary winding to the secondary winding to provide a DC output voltage to drive the LED-based light source; a power factor controller circuit configured to provide an output signal to control the switch; and a supply voltage circuit coupled to the feedback winding and configured to provide a supply voltage to the power factor controller circuit at the high end of a nominal supply voltage operating range of the power factor controller circuit.

In a related embodiment, the supply voltage circuit may include: a first energy storage circuit coupled to the rectifier circuit to receive the unregulated DC voltage, wherein the first energy storage circuit may include a first energy storage element coupled to the power factor controller circuit to provide the supply voltage; and a second energy storage circuit coupled to the feedback winding, wherein the second energy storage circuit may include a second energy storage element; wherein current from the unregulated DC voltage may charge the first energy storage element and wherein current through the feedback winding may charge the second energy storage element and the first energy storage element. In a further related embodiment, the first energy storage element may include a first capacitor and the second energy storage element may include a second capacitor. In a further related embodiment, the first capacitor and the second capacitor may be coupled in parallel.

In another related embodiment, the lamp assembly may further include: an output; and an open circuit protection circuit coupled to the secondary winding and to the power factor controller circuit, the open circuit protection circuit configured to disable the power factor controller circuit when an open circuit occurs at the output. In a further related embodiment, the open circuit protection circuit may optically couple the secondary winding to the power factor controller circuit. In another further related embodiment, the open circuit protection circuit may include an optically isolated switch coupled to the power factor controller circuit and optically coupled to the secondary winding, the switch being configured to close when the open circuit occurs at the output.

In yet another related embodiment, the secondary winding may be capacitively coupled to the feedback winding, the capacitive coupling to provide electromagnetic interference (EMI) filtering.

In another embodiment, there is provided a method of driving an LED-based light source. The method includes: receiving an AC input signal; converting the AC input signal into a regulated DC output; controlling a power factor of the regulated DC output using a power factor controller circuit; providing a supply voltage to the power factor controller circuit at the high end of a nominal supply voltage operating range of the power factor controller circuit; and coupling the regulated DC output to the LED-based light source.

In a related embodiment, converting may include: operating a switch to energize a transformer having a primary winding, at least one secondary winding, and a feedback winding, wherein the primary winding is coupled to the rectifier circuit and the at least one secondary winding is configured to be coupled to the LED-based light source; and controlling may include: controlling the switch; and the method may further include: coupling an open circuit protection circuit to the secondary winding and to the power factor controller circuit to disable the power factor controller circuit when the LED-based light source fails in an open state. In a further related embodiment, coupling an open circuit protection circuit may include optically coupling the secondary winding to the power factor controller circuit. In a further related embodiment, the method may further include capacitively coupling the secondary winding to the feedback winding.

In another embodiment, there is provided a driver circuit for a solid state light source. The driver circuit includes: an input stage comprising a rectifier circuit and a filter circuit, wherein the input stage is configured to receive an AC input voltage, to filter the received AC input voltage, and to rectify the received AC input voltage so as to provide a filtered unregulated DC voltage; a transformer having a primary winding coupled to the input stage, at least one secondary winding configured to be coupled to the solid state light source, and a feedback winding, the secondary winding being electrically isolated from the primary winding and the feedback winding with no electrical path between the primary winding and the secondary winding or the feedback winding and the secondary winding; a switch, the switch being configured to close to couple a portion of the filtered unregulated DC voltage across the primary winding and the switch being configured to open to transfer energy from the primary winding to the secondary winding to provide a DC output voltage to drive the solid state light source; and a power factor correction circuit configured to control the switch in response to a first signal representative of current through the primary winding, a second signal representative of current through the feedback winding, and a third signal representative of the filtered unregulated DC voltage, with no feedback signal coupled from the secondary winding to the power factor correction circuit.

In a related embodiment, the filter circuit may include a first filter stage, wherein the first filter stage may include a series combination of a capacitor and a resistor in parallel across an input on which the AC input voltage is received, a first combination of an inductor in parallel with a resistor on a high side of the AC input voltage, and a second combination of an inductor in parallel with a resistor on a low side of the AC input voltage. In a further related embodiment, the filter circuit may be configured to reduce input capacitance at the input stage and to dampen an LC value associated with the input stage. In another further related embodiment, the filter circuit may further include a second filter stage, wherein the second filter stage comprises a first filter capacitor, a second filter capacitor, and an inductor. In a further related embodiment, the first filter stage may be configured to filter the AC input voltage and the second filter stage may be configured to filter the unregulated DC voltage provided by the rectifier circuit from the filtered AC input voltage.

In another related embodiment, the driver circuit may further include a protection circuit coupled between the feedback winding of the transformer and the power factor correction circuit to disable the power factor correction circuit when an open circuit condition exists. In a further related embodiment, the protection circuit may include a Zener diode.

In still another related embodiment, the driver circuit may further include an energy transfer circuit coupled between the primary winding of the transformer and the power factor correction circuit to transfer energy away from the switch to the power factor controller circuit. In a further related embodiment, the energy transfer circuit may include a resistor in parallel with a capacitor.

In another embodiment, there is provided a lamp assembly. The lamp assembly includes: a lamp housing; a solid state light source disposed within the lamp housing; and a driver circuit for the solid state light source, the driver circuit including: an input stage comprising a rectifier circuit and a filter circuit, wherein the input stage is configured to receive an AC input voltage, to filter the received AC input voltage, and to rectify the received AC input voltage so as to provide a filtered unregulated DC voltage; a transformer having a primary winding coupled to the input stage, at least one secondary winding configured to be coupled to the solid state light source, and a feedback winding, the secondary winding being electrically isolated from the primary winding and the feedback winding with no electrical path between the primary winding and the secondary winding or the feedback winding and the secondary winding; a switch, the switch being configured to close to couple a portion of the filtered unregulated DC voltage across the primary winding and the switch being configured to open to transfer energy from the primary winding to the secondary winding to provide a DC output voltage to drive the solid state light source; and a power factor correction circuit configured to control the switch in response to a first signal representative of current through the primary winding, a second signal representative of current through the feedback winding, and a third signal representative of the filtered unregulated DC voltage, with no feedback signal coupled from the secondary winding to the power factor correction circuit.

In a related embodiment, the filter circuit may include a first filter stage, wherein the first filter stage may include a series combination of a capacitor and a resistor in parallel across an input on which the AC input voltage is received, a first combination of an inductor in parallel with a resistor on a high side of the AC input voltage, and a second combination of an inductor in parallel with a resistor on a low side of the AC input voltage. In a further related embodiment, the filter circuit may be configured to reduce input capacitance at the input stage and to dampen an LC value associated with the input stage. In another further related embodiment, the filter circuit may further include a second filter stage, wherein the second filter stage comprises a first filter capacitor, a second filter capacitor, and an inductor. In a further related embodiment, the first filter stage may be configured to filter the AC input voltage and the second filter stage may be configured to filter the unregulated DC voltage provided by the rectifier circuit from the filtered AC input voltage.

In another related embodiment, the driver circuit may further include a protection circuit coupled between the feedback winding of the transformer and the power factor correction circuit to disable the power factor correction circuit when an open circuit condition exists. In a further related embodiment, the protection circuit may include a Zener diode.

In still another related embodiment, the driver circuit may further include an energy transfer circuit coupled between the primary winding of the transformer and the power factor correction circuit to transfer energy away from the switch to the power factor controller circuit. In a further related embodiment, the energy transfer circuit may include a resistor in parallel with a capacitor.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 shows a block diagram of a system including an optional dimmer circuit and an LED-based lamp assembly according to embodiments disclosed herein.

FIG. 2 illustrates a block diagram of an LED ballast circuit according to embodiments disclosed herein.

FIG. 3 is a circuit diagram of an LED ballast circuit according to embodiments disclosed herein.

FIG. 4 is a circuit diagram of another LED ballast circuit according to embodiments disclosed herein.

FIG. 5 is a flow diagram of a method according to embodiments disclosed herein.

FIG. 6 shows a block diagram of a lamp assembly and dimmer circuit according to embodiments disclosed herein.

FIG. 7 is a block diagram of a solid state light source driver circuit according to embodiments disclosed herein.

FIG. 8 is a block diagram of a supply voltage circuit according to embodiments disclosed herein.

FIG. 9 is a circuit diagram of a solid state light source driver circuit according to embodiments disclosed herein.

FIGS. 10 and 11 are block flow diagrams of methods according to embodiments disclosed herein.

FIG. 12 is a block diagram of a solid state light source driver circuit according to embodiments disclosed herein.

FIG. 13 is a circuit diagram of a solid state light source driver circuit according to embodiments disclosed herein.

FIG. 14 is a circuit diagram of a solid state light source driver circuit according to embodiments disclosed herein.

### DETAILED DESCRIPTION

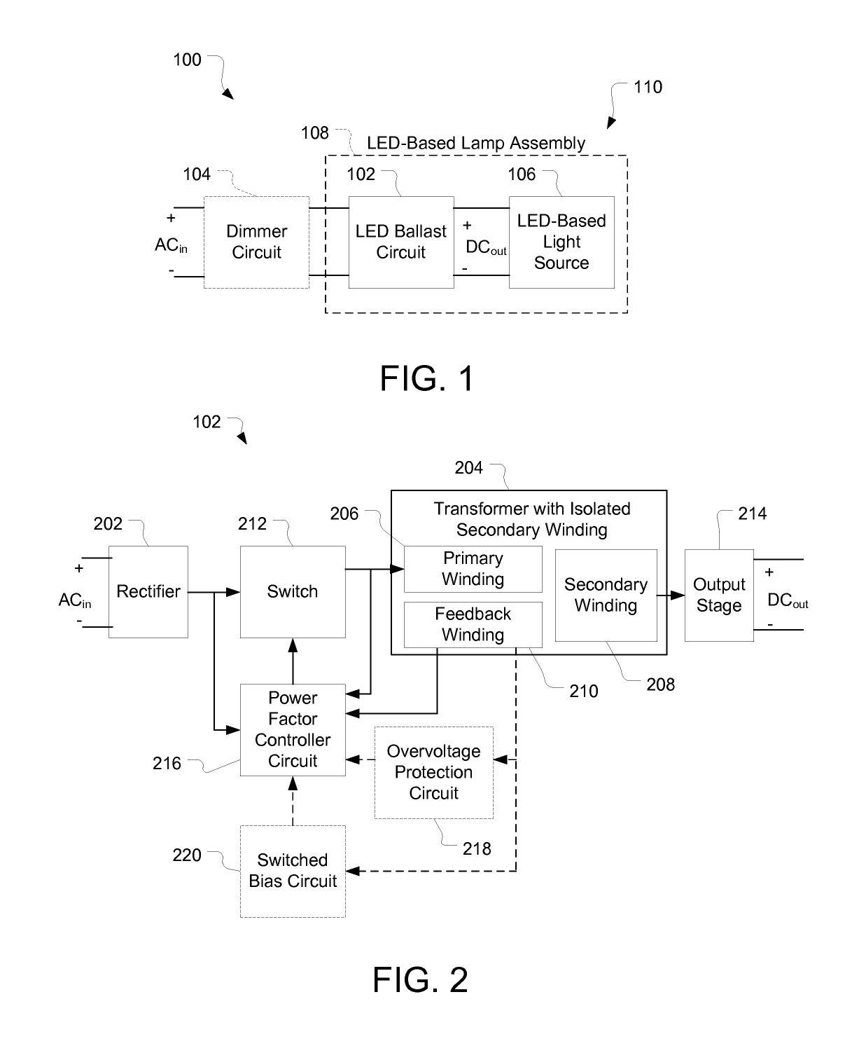

FIG. 1 is a simplified block diagram of one exemplary embodiment of a system 100 consistent with the present disclosure. In general, the system includes a light emitting diode (LED) ballast circuit 102 consistent with the present disclosure for receiving an alternating current (AC) input ACᵢₙ, either directly or through a known dimmer circuit 104, and providing a regulated direct current (DC) output DCₒᵤₜ for driving an LED-based light source 106. The LED-based light source 106 may be a single LED or multiple LEDs interconnected in series and/or parallel configurations. In one embodiment, ACᵢₙ may be a provided directly from a 120 VAC/60 Hz line source. It is to be understood, however, that a system consistent with the present application may operate from AC sources, such as a 220-240 VAC at 50-60 Hz. In an embodiment including a dimmer circuit 104, the dimmer circuit may be any known dimmer circuit configuration, such as a reverse phase control dimmer circuit. The configuration and operation of such dimmer circuits are well-known in the art.

The LED ballast circuit 102 may convert the AC input voltage ACᵢₙ to a regulated DC output voltage DCₒᵤₜ with a high power factor, high efficiency, small size and protective isolation. The LED ballast circuit 102 and the LED-based light source 106 may thus be provided within a single lamp housing 108, such as within the housing of a parabolic aluminized reflector (PAR) lamp, to provide a LED-based lamp assembly 110 consistent with the present disclosure. The LED-based lamp assembly 110 provides a convenient retro-fit for existing lighting fixtures configured to energize PAR lamps including non-LED based light sources, e.g. fluorescent or gas-discharge sources. An LED-based lamp assembly 110 consistent with the present disclosure may be inserted directly into such a lighting fixture to operate on the AC input thereto, and may operate with a known dimmer circuit. A lamp including an LED-based light source 106 may provide long life and low power consumption compared to those including non-LED-based light sources.

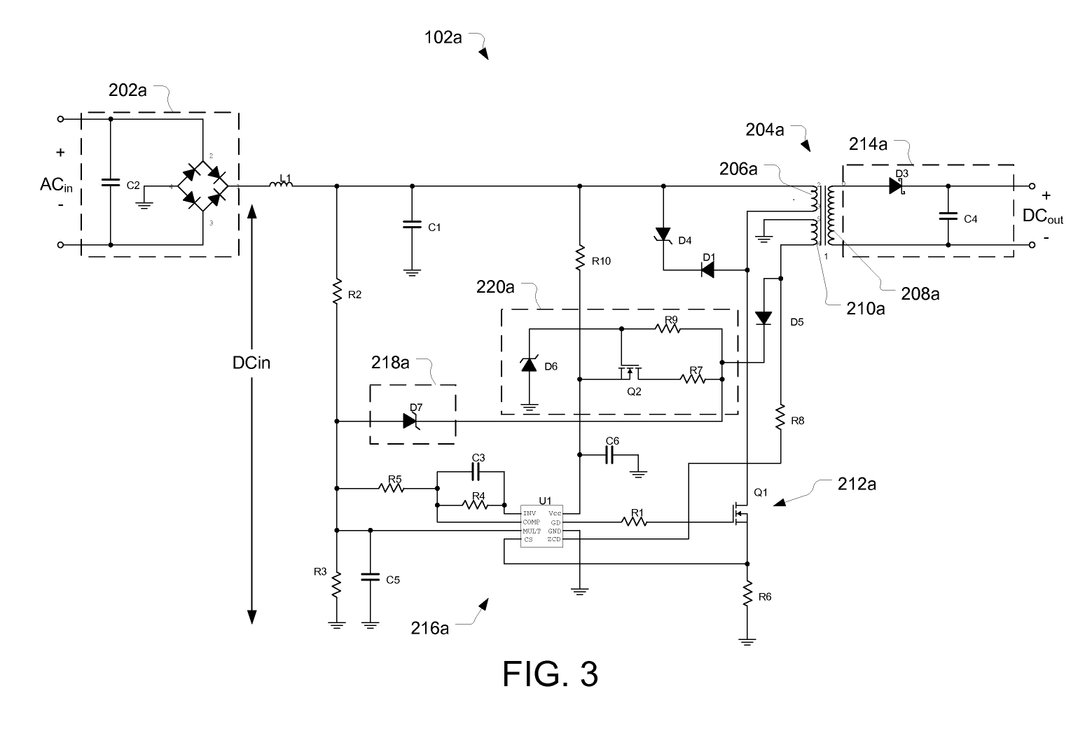

FIG. 2 is a block diagram that conceptually illustrates the functionality of an LED ballast circuit 102 consistent with the present disclosure. As shown, an LED ballast circuit 102 consistent with the present disclosure may include a rectifier 202, a transformer 204 including a primary winding 206, secondary winding 208 and a feedback winding 210, a switch 212 for coupling the output of the rectifier 202 to the primary winding 206 of the transformer 204, an output stage 214 coupled to a secondary winding 208 of the transformer, and a power factor controller circuit 216. The ballast circuit may also include an over-voltage protection circuit 218 and/or a switched bias circuit 220. The term “coupled” as used herein refers to any connection, coupling, link or the like by which signals carried by one system element are imparted to the “coupled” element. Such “coupled” devices, or signals and devices, are not necessarily directly connected to one another and may be separated by intermediate components or devices that may manipulate or modify such signals.

In general, the AC input voltage ACᵢₙ may be coupled to the rectifier circuit 202, either directly or through a dimmer circuit 104. The rectifier circuit 202 may be configured to rectify ACᵢₙ to provide an unregulated DC output voltage, i.e. a DC output voltage that follows instantaneous variations in the AC input voltage. A variety of rectifier circuit configurations are well-known in the art. In one embodiment, for example, the rectifier circuit 202 may include a known bridge rectifier.

The output of the rectifier 202 may be coupled to the primary winding 206 of the transformer through the switch 212 under the control of the power factor controller circuit 216. The switch 212 may be a known transistor switch, as is commonly used in known switching regulator configurations. In general, when the switch 212 is “closed”, the primary winding 206 of the transformer 204 is coupled to the output of the rectifier 202 and the energy is stored in transformer windings. When the switch is “open”, the energy stored in the secondary winding 208 is coupled to the output stage 214. The output stage 214 may include a capacitor that is charged by the energy from the secondary winding 208 and discharges through the LED-based light source 106 to drive the light source.

The power factor controller circuit 216 may include a known power factor controller (not shown) configured to provide an output to the switch 212 for controlling the switch 212 in response to a signal representative of current through the primary winding 206, a second signal representative of current through the feedback winding 210, and a third signal representative of the unregulated DC voltage, with no feedback signal coupled from the secondary winding 208 to the controller. The output from the power controller may control the switch so that the current to the LED-based light source 106 has a waveform that substantially matches and is in phase with the output of the rectifier 202, thereby providing high power factor.

Known power factor controllers useful in an LED ballast configuration consistent with the present disclosure include known integrated circuit power factor correction controllers, such as model number L6561 and L6562 controllers presently available from ST Microelectronics of Sunnyvale, Calif. The L6561 and L6563 controllers may, for example, be employed as a controller in a “flyback” DC-DC converter implementation. Details of this and related alternative applications of the L6561 controller are discussed in ST Microelectronics Application Note AN1060, “Flyback Converters with the L6561 PFC Controller,” by C. Adragna and G. Garravarik, January 2003, and ST Microelectronics Application Note AN1059, “Design Equations of High-Power-Factor Flyback Converters based on the L6561,” by Claudio Adragna, September 2003, each of which is available at http://www.st.com and incorporated herein by reference. Specifically, Application Notes AN1059 and AN1060 discuss one exemplary configuration for an L6561-based flyback converter (High-PF flyback configuration) that operates in transition mode and exploits the ability of the L6561 controller to perform power factor correction, thereby providing a high power factor single switching stage DC-DC converter. Differences between the L6561 and L6562 controllers are discussed in ST Microelectronics Application Note AN1757, “Switching from the L6561 to the L6562,” by Luca Salati, April 2004, also available at http://www.st.com and incorporated herein by reference. For purposes of the present disclosure, these two controllers may be discussed as having similar functionality.

In a ballast 102 consistent with the present disclosure, the secondary winding 208 of the transformer is not electrically coupled in any way to the primary 206 or feedback winding 210, e.g. there is no common ground electrical path for the windings and there is no feedback path coupled from the secondary winding 208 to the power factor controller circuit 216 or any other element on primary winding side of the ballast. The power factor controller operates using signals coupled thereto from the output of the rectifier 202, and the primary 206 and feedback windings 210, but no feedback signal is coupled, e.g. electrically or optically, from the secondary winding 208 to the controller. This provides complete protective isolation for the high voltages on the primary winding side of the transformer and the secondary side of the transformer. In addition, by not requiring feedback from the secondary winding 208, the overall size and complexity of the ballast is reduced compared to configurations wherein, for example, optically isolated feedback is provided from the secondary winding 208 to the controller.

As is known, the supply voltage for operating a power factor controller may be self-supplied in the ballast configuration to ensure a regulated, stable supply to the circuit during operation. In a ballast configuration consistent with the present disclosure including the optional switched bias circuit 220, the switched bias circuit 220 may establish a supply voltage to the controller with low transient response time and low power dissipation. In the illustrated embodiment, the switched bias circuit 220 is coupled between the feedback winding 210 and the power factor correction circuit 216. In an embodiment including a L6561 or L6562 power controller, for example, the switched bias circuit may be coupled to the Vcc input of the power factor controller and may include a transistor switch that turns on when the switch 212 is opened to use energy transferred from the feedback winding 210 for providing a voltage supply to the power factor controller. Such a configuration provides rapid transient response that may be particularly useful when the system is implemented with a dimmer circuit 104, such as a phased controlled dimmer circuit.

The optional over-voltage protection circuit 218 may be provided to shut down or prohibit operation of the power factor controller circuit 216 upon the occurrence of an over-voltage condition. For example, if the LED-based load 106 ceases conducting current from the secondary winding 208, e.g. if the load is not connected or malfunctions, a dangerous over-voltage condition on the terminals of the transformer 204 may arise. In the illustrated embodiment, the over-voltage protection circuit 218 is coupled between the feedback winding 210 and the power factor correction circuit 216. In an embodiment including a L6561 or L6562 power controller for example, the over-voltage protection circuit 218 may be coupled to the INV or ZCD input of the power factor controller for shutting the controller down if an over-voltage condition exists.

The optional switched bias circuit 220 and over-voltage protection circuit 218 are described herein as being useful in connection with a ballast wherein the secondary winding is completely isolated from the primary and feedback windings and no feedback is coupled from the secondary winding to the power factor controller. Those of ordinary skill in the art will recognize, however, that these circuits 218, 220 may be provided in a wide variety of ballast configurations. For example, these circuits may be included in a ballast configuration including different transformer or feedback configuration.

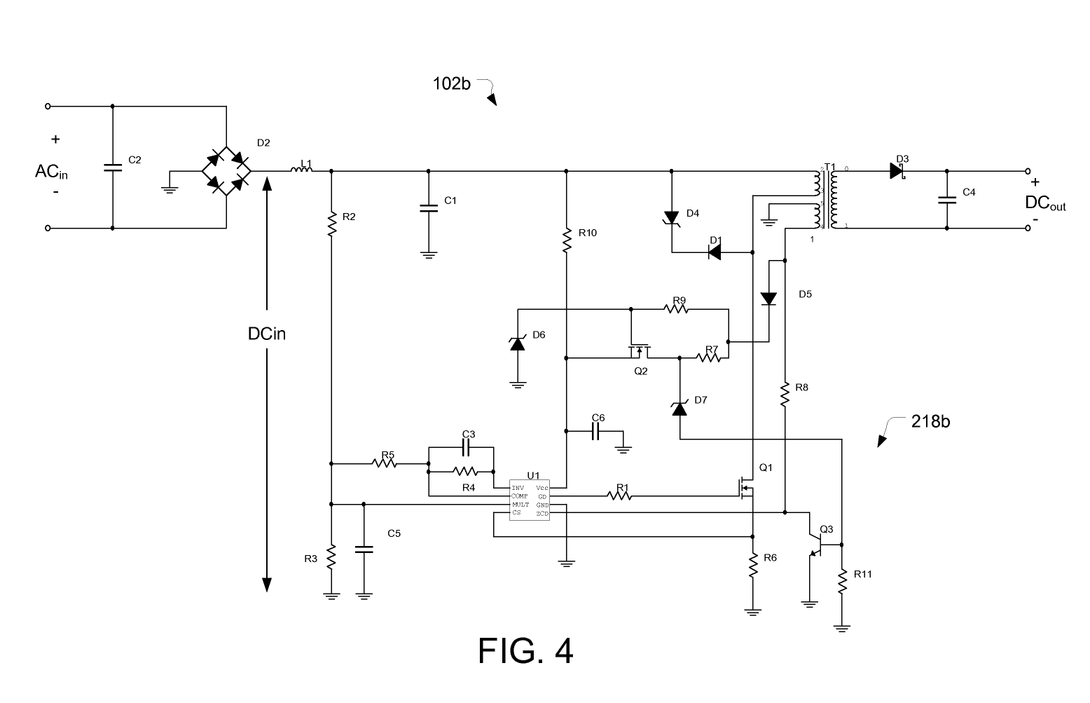

FIG. 3 is a schematic diagram illustrating one exemplary embodiment of an LED ballast circuit 102a consistent with the present disclosure. The illustrated exemplary embodiment includes a rectifier circuit 202a, a transformer 204a including a primary winding 206a, a secondary winding 208a and a feedback winding 210a, a switch Q2 (212a) for coupling the output of the rectifier circuit 202a to the primary winding 206a of the transformer 204a, an output stage 214a coupled to a secondary winding 208a of the transformer 204a, a power factor controller circuit 216a, an over-voltage protection circuit 218a, and a switched bias circuit 220a. The power factor controller circuit 216a includes an L6561 integrated circuit power factor controller U1, the operation of which is known and described in ST Microelectronics Application Notes AN1060 and AN1059, referred to above. Those of ordinary skill in the art will recognize, however, that other known power factor controllers may be used in place of the L6561 controller shown in FIG. 3.

In operation, the AC input to the circuit ACᵢₙ is coupled to the rectifier circuit 202a, which includes a known bridge rectifier. The rectifier full-wave rectifies the AC input to provide a rectified unregulated DC voltage DCᵢₙ. The output of the rectifier DCᵢₙ is connected to L1 and C1, which filter noise generated in the circuit.

The primary winding 206a of the transformer 204a is coupled between the output of the rectifier circuit 202a and the drain of Q1 so that when Q1 is conducting, i.e. the switch is closed, current flows from the output of the rectifier circuit 202a through the primary winding 206a to energize the primary winding 206a, but when Q1 is not conducting, i.e. the switch is open, essentially no current flows through the primary winding 206a. In general, when the switch Q1 is closed, the windings of the transformer 204a are energized, and when the switch Q1 opens, the polarity of the voltage across the secondary winding 208a and the feedback winding 210a reverses to forward bias diodes D3 and D5. When diode D3 is forward biased, energy from the secondary winding 208a charges capacitor C4, which is configured to discharge through the load when the switch Q1 is open.

In general, the power factor controller U1 uses a voltage representative of the output of the rectifier circuit 202a (i.e., DCᵢₙ) as a reference to control the level at which the controller U1 switches the switch Q1 on and off using a gate drive GD output coupled to the gate of Q1 through R1. This feature allows for a very high power factor ballast. The switching frequency is determined by feedback from the primary winding 206a and the feedback winding 210a.

In particular, a portion of DCᵢₙ is coupled to the multiplier input MULT of the controller U1 to provide a signal to the controller U1 representative of the unregulated DC voltage DCᵢₙ. The MULT input is coupled between R2 and the parallel combination of R3 and C5. Selection of R3 and C5 allows for a tradeoff between ripple and power factor correction in the output voltage DCₒᵤₜ established by the controller U1. The source of Q1 is coupled to the current sense C5 input of the controller U1 and to ground through R6. The current through R6 thus provides a signal to the controller U1 representative of the current through the primary winding 206a. The feedback winding 210a of the transformer 204a is coupled through R8 to the zero current detection input ZCD of the controller U1 to provide a signal to the controller U1 representative of the current through the feedback winding 210a. In response to the MULT, ZCD and CS inputs, the controller U1 provides a variable frequency gate drive GD output to Q1 for driving the load with a high power factor.

Bias voltage is supplied to the power controller supply voltage input Vcc through R10, which is coupled to Vcc through the switched bias circuit 220a. When there is no starting pulse at the gate of Q1, no current is provided from the rectifier output to energize the transformer windings 206a, 208a, 210a. Once the voltage on Vcc reaches its minimum value, the gate drive output GD of the controller U1 provides a starting pulse to the gate of Q1 through R1 to close the switch Q1 so that at least a portion of the rectifier output is provided across the primary winding 206a to energize the transformer windings 206a, 208a, 210a.

The drain current in Q1 begins to ramp up at a rate determined by the primary inductances of the transformer 204a. This current produces a voltage across R6, which is representative of the current through the primary winding 206a. This current is fed into the current sense CS input of the controller U1. The controller U1 compares this voltage to the voltage on the multiplier input MULT and the voltage on inverting input INV, which is set by R2, R3, and the parallel combination of R4 and C3 coupled in series with R5. When the voltage conditions are met according to the switching characteristics set by the controller U1, the drive to Q1 is removed. This causes the voltage across the primary winding 206a and the secondary winding 208a of the transformer 204a to reverse. The energy stored in the transformer 204a is then transferred to the output via D3. During this same time interval, the transformer 204a provides a voltage on the feedback winding 210a that forward biases D5 to provide current to the switched bias circuit 220a.

In the illustrated embodiment, the switched bias circuit 220a includes bias circuit switch Q2, R7, R9, and Zener diode D6. R9 and D6 are coupled to the gate of Q2, R7 is coupled to the source of Q2, and the drain of Q2 is coupled to R10, C6, and the Vcc input of the controller U1. D5 is coupled to R9 and R7. When D5 is forward biased, a current is established through R9 that turns Q2 on once the gate signal reaches the threshold voltage of Q2. Q2 charges C6, which provides supply voltage to the Vcc input. Q2 switches on quickly to provide supply voltage to Vcc with low power dissipation. After all the energy is removed from the transformer, the voltage on the feedback winding drops to zero. This negative transition on the zero current detection input ZCD of the controller U1 instructs it to start a new cycle. After several cycles, the bias voltage on Vcc reaches its normal operating level determined by the Zener diode D6.

The over-voltage protection circuit 218a in the illustrated embodiment includes Zener diode D7. When D5 is forward biased by the feedback winding 210a, if the voltage across the feedback winding 210a exceeds a predetermined acceptable level, the breakdown voltage of D7 is exceeded and voltages are established at the inverting input INV and COMP input by R5, R4, and C3 that will shut down the controller U1 to open Q1. The over-voltage protection circuit 218a thus disables the current supply to the transformer 204a to provide protection against dangerous voltages occurring in the circuit due, for example, to disconnection or malfunction of the load.

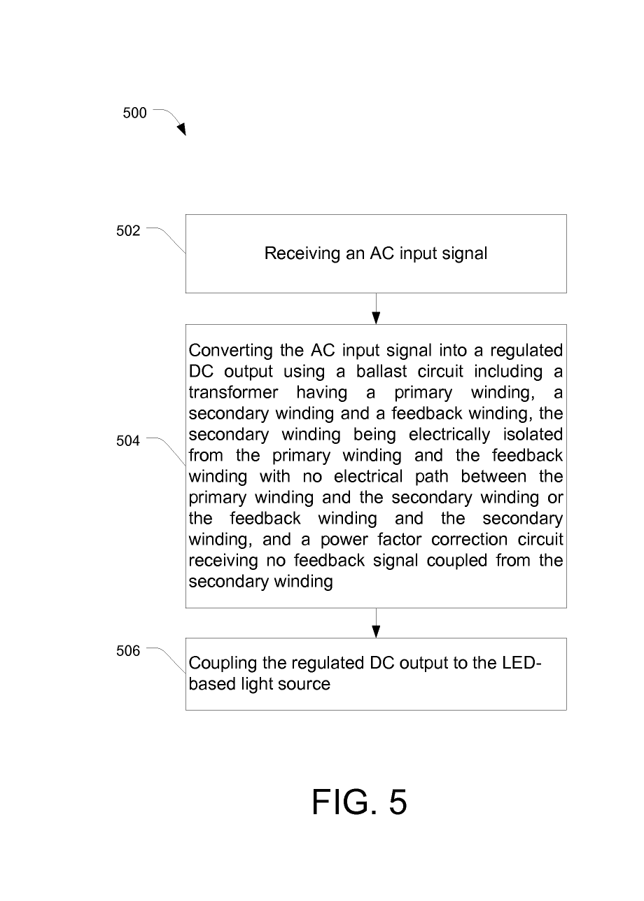

FIG. 4 is a schematic diagram illustrating another exemplary embodiment 102b of an LED ballast circuit consistent with the present disclosure. The embodiment illustrated in FIG. 4 is configured and operates in essentially the same manner as described above with respect to FIG. 3, with the main differences being in the configuration and operation of the over-voltage protection circuit, and a further difference being that the controller in FIG. 4 is a L6562 controller.

The over-voltage protection circuit 218b in FIG. 4 includes Zener diode D7, R5, over-voltage protection circuit switch Q3 and R11. The collector of Q3 is coupled to the zero current detection input ZCD of the controller. When D5 is forward biased by the feedback winding, if the voltage across the feedback winding exceeds a predetermined acceptable level, the breakdown voltage of D7 is exceeded and a voltage is established across R11 at the base of Q3 that turns Q3 on. When Q3 is on a current is established through R8 to provide a voltage at the ZCD input that will shut down the controller to open Q1. The over-voltage protection circuit 218b thus disables the current supply to the transformer to provide protection against dangerous voltages occurring in the circuit due, for example, to disconnection or malfunction of the load.

A ballast circuit consistent with the present disclosure may be configured for operation with a variety of input voltages based on appropriate selection of various circuit components thereof. Table 1 below identifies one example of circuit components useful in configuring the embodiment illustrated in FIG. 4 for operation with a 120V RMs/60 Hz AC input signal (resistor values in ohms):

TABLE 1

| | Descriptor/ |
|---|---|
| Component | Value |
| ACin | 120 VAC/60 Hz |
| C1 | 200 nf |
| C2 | 200 nF |
| C3 | 1 nF |
| C4 | 10 uf |
| C5 | 1 nF |
| C6 | 10 uF |
| D1 | 1 A |
| D3 | 1 A |
| D4 | 220 V |
| D5 | BAS16 |
| D6 | 15 V |
| D7 | 35 V |
| Dout | 27 V DC |
| L1 | 222 uH |
| Q1 | TK4P60 |
| Q2 | BSS131 |
| Q3 | 2N2222 |
| R1 | 10 |
| R2 | 1M |
| R3 | 6.8k |
| R4 | 180k |
| R5 | 98.9k |
| R6 | 2 |
| R7 | 10 |
| R8 | 47k |
| R9 | 100k |
| R10 | 110k |
| R11 | 5K |
| T1 | 22 mm EI |
| | core |
| | LP = |
| | 1.5 mH |

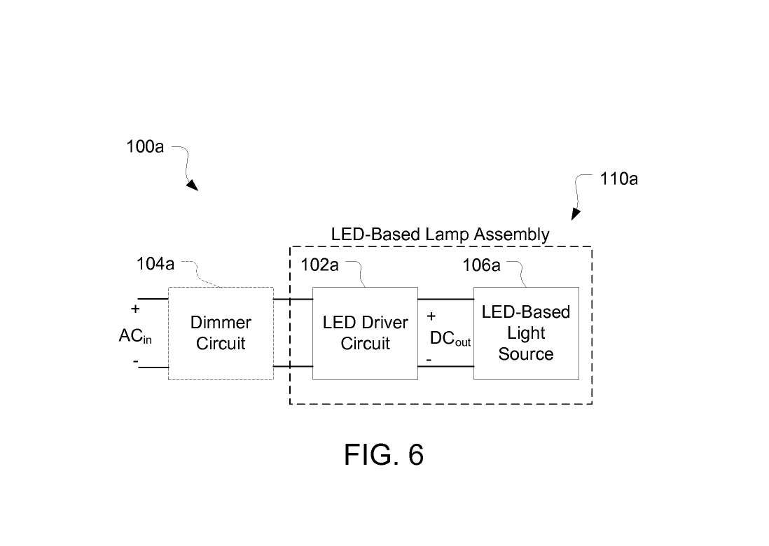

FIG. 5 is a block flow diagram of a method 500 for driving an LED-based light source consistent with the present disclosure. The illustrated block flow diagram may be shown and described as including a particular sequence of steps. It is to be understood, however, that the sequence of steps merely provides an example of how the general functionality described herein may be implemented. The steps do not have to be executed in the order presented unless otherwise indicated.

In the exemplary embodiment illustrated in FIG. 5, an AC input signal is received 502. The AC input signal is converted 504 into a regulated DC output using a ballast circuit including a transformer having a primary winding, a secondary winding and a feedback winding, the secondary winding being electrically isolated from the primary winding and the feedback winding with no electrical path between the primary winding and the secondary winding or the feedback winding and the secondary winding, and a power factor correction circuit receiving no feedback signal coupled from the secondary winding. The DC output is coupled 506 to the LED-based light source to drive the light source.

Embodiments described herein also provide circuits and methods for implementing a solid state light source driver. The driver may be used in combination with one or more solid state light sources in any type of configuration, such as but not limited to a lamp, lamp assembly, fixture, system, and the like. The solid state light source may be, but is not limited to, one or more light emitting diodes (LEDs), organic light emitting diodes (OLEDs), polymer light emitting diodes (PLEDs), and the like. Though embodiments may be, and in some cases are, described herein with reference to LEDs, any type of solid state light source and/or sources may be used without departing from the scope of the invention. The driver includes a power factor controller circuit and a supply voltage circuit configured to provide a supply voltage to the power factor controller circuit, such that the supply voltage is maintained within the high end of a nominal supply voltage operating range of the power factor controller circuit. Providing a supply voltage at the high end of a nominal supply voltage operating range of the power factor controller circuit allows for the use of small, non-electrolytic, capacitors in the supply voltage circuit, while still providing sufficient energy storage to allow for operation of the power factor controller circuit in conjunction with a dimmer circuit. This may result in a reduced cost and size of the driver, while still maintaining a low THD and high power factor.

Embodiments of a solid state light source driver as described herein may also, or alternatively, include an open circuit protection circuit for disabling the power factor controller circuit when an open circuit occurs in the load. The open circuit protection circuit provides protection against dangerous and potentially damaging voltages at the circuit output. Protection against electromagnetic interference (EMI) may also be provided in a driver according to embodiments described herein.

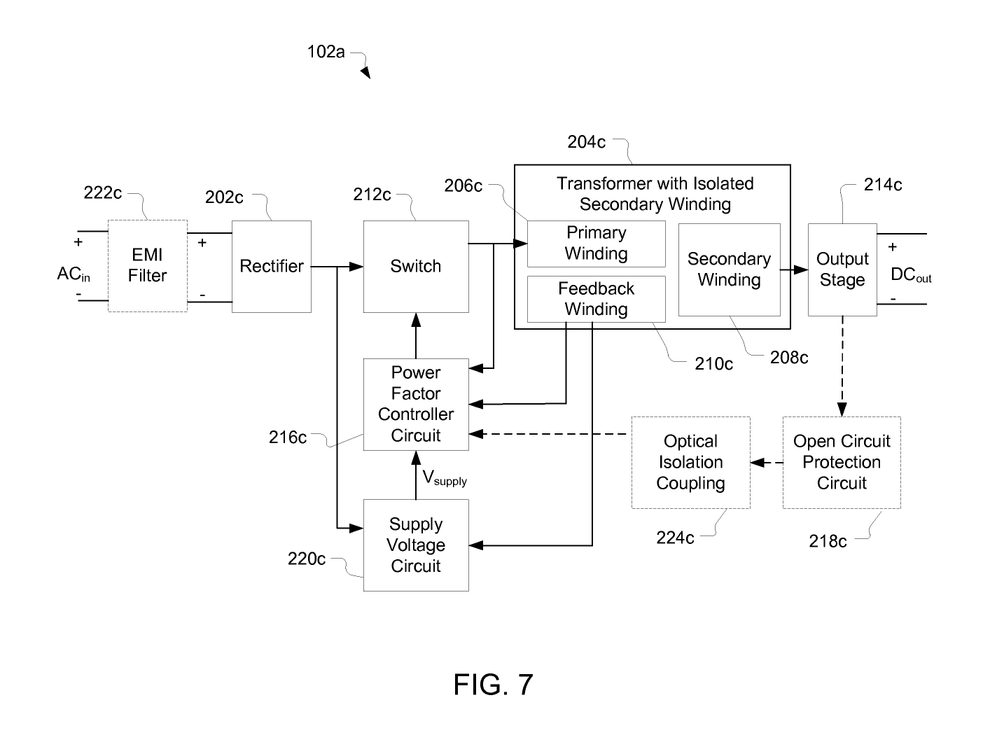

Turning now to FIG. 6, there is shown a simplified block diagram of a system 100a that includes a light emitting diode (LED) driver circuit 102a for receiving an alternating current (AC) input ACᵢₙ, either directly or through a known dimmer circuit 104a, and providing a regulated direct current (DC) output DCₒᵤₜ for driving an LED-based light source 106a, similar to the system 100 of FIG. 1. In FIG. 6, the LED-based light source 106a may include a single LED, multiple LEDs interconnected in series and/or parallel configurations, and/or combinations of one or more LEDs and one or more other solid state light sources (e.g. OLED(s), PLED(s), etc.). In some embodiments, ACᵢₙ may be provided directly from a 120 VAC/60 Hz line source. It is to be understood, however, that any known type of AC source, such as but not limited to a 220-240 VAC at 50-60 Hz, may be used without departing from the scope of the invention. In embodiments including a dimmer circuit 104a, the dimmer circuit 104a may take any known dimmer circuit configuration, such as but not limited to a standard forward or reverse “phase control” or “phase cut” dimmer provided in a wall switch, the operation of which is well-known. As described above, in a phase control dimmer circuit configuration, the dimmer circuit 104a cuts a fraction of the input voltage sine-wave ACᵢₙ in each period of the waveform to provide an AC input to the driver circuit having an associated dimmer setting.

The LED driver circuit 102a may convert the AC input voltage ACᵢₙ to a regulated DC output voltage DCₒᵤₜ with a high power factor, low THD, high efficiency, small size, and protective isolation. The LED driver circuit 102a and the LED-based light source 106a may thus be provided within an LED-based lamp assembly 110a according to embodiments described herein. The LED-based lamp assembly 110a may provide a convenient retro-fit for existing lighting fixtures configured to energize lamps including non-LED based light sources, e.g. fluorescent or gas-discharge sources. An LED-based lamp assembly 110a according to embodiments described herein may be inserted directly into such a lighting fixture to operate on the AC input thereto, and may operate with a known dimmer circuit including forward phase control and reverse phase control dimmer circuits. A lamp including an LED-based light source 106a may provide long life and low power consumption compared to those including non-LED-based light sources.

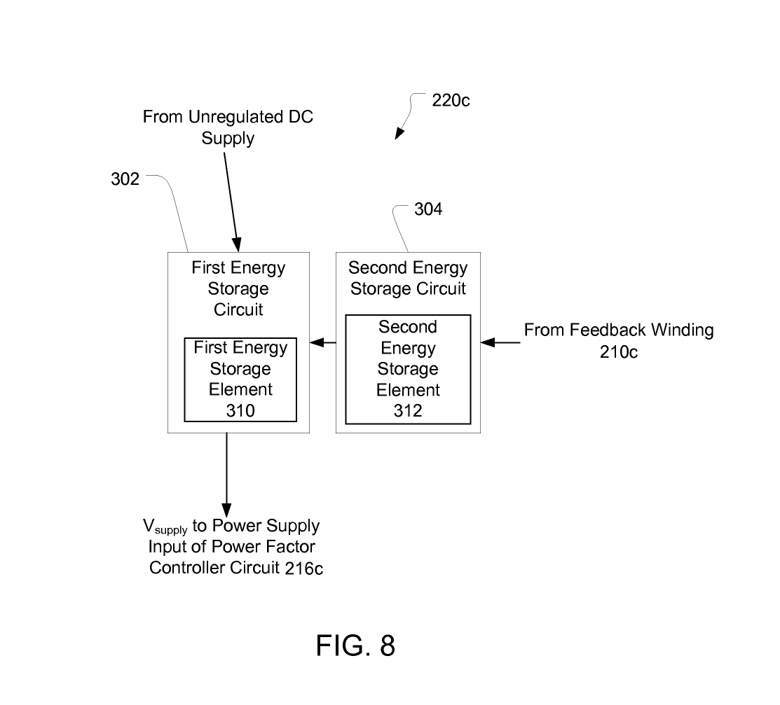

FIG. 7 is a block diagram that conceptually illustrates the functionality of an LED driver circuit, such as the LED driver circuit 102a shown in block form in FIG. 6. As shown, an LED driver circuit 102a includes an optional electromagnetic interference (EMI) filter 222c, a rectifier 202c, a transformer 204c including a primary winding 206c, a secondary winding 208c, and a feedback winding 210c, a switch 212c for coupling the output of the rectifier 202c to the primary winding 206c of the transformer 204c, an output stage 214c coupled to a secondary winding 208c of the transformer, a power factor controller circuit 216c, and a supply voltage circuit 220c. The LED driver circuit 102a may also include an optional open circuit protection circuit 218c coupled to the power factor controller circuit 216c through an optically isolated coupling 224c.

In general, the AC input voltage ACᵢₙ may be coupled to the EMI filter circuit 222c or the rectifier circuit 202c, either directly or, for example, through a dimmer circuit such as the dimmer circuit 104a shown in FIG. 6. The EMI filter circuit 222c may be configured to reduce EMI noise and to dampen ringing associated with forward phase control dimmers, such as but not limited to triac-based dimmers. In some embodiments, component values of the EMI filter circuit 222c may be chosen to adjust the phase angle between the input voltage and the input current to achieve lower THD.

The rectifier circuit 202c may be configured to rectify ACᵢₙ to provide an unregulated DC output voltage, i.e. a DC output voltage that follows instantaneous variations in the AC input voltage. A variety of rectifier circuit configurations are well-known in the art. In some embodiments, for example, the rectifier circuit 202c may include a known bridge rectifier. The output of the rectifier circuit 202c may be coupled to the primary winding 206c of the transformer 204c through the switch 212c under the control of the power factor controller circuit 216c. The switch 212c may be a known transistor switch, as is commonly used in known switching regulator configurations. In general, when the switch 212c is “closed,” the primary winding 206c of the transformer 204c is coupled to the output of the rectifier circuit 202c and the energy is stored in the windings of the transformer 204c. When the switch is “open,” the energy stored in the secondary winding 208c is coupled to the output stage 214c. The output stage 214c may include a capacitor that is charged by the energy from the secondary winding 208c and discharges through the LED-based light source 106a to drive the light source.

The power factor controller circuit 216c may include a known power factor controller configured to provide an output to the switch for controlling the switch in response to a first signal representative of current through the feedback winding 210c and a second signal representative of current through the primary winding 206c. The power factor controller circuit 216c may also respond to a signal provided by the optional open circuit protection circuit that is representative of voltage across the secondary winding 208c. The output from the power factor controller may control the switch so that the current to the LED-based light source 106a has a waveform that substantially matches and is in phase with the output of the rectifier circuit 202c, thereby providing high power factor. Known power factor controllers useful in an LED driver configuration, such as any embodiment described herein, include known integrated circuit power factor correction controllers, such as model number L6561 and L6562 controllers presently available from ST Microelectronics of Sunnyvale, Calif. The L6561 and L6562 controllers may, for example, be employed as a controller in a flyback DC-DC converter implementation. Details of this and related alternative applications of the L6561 controller are discussed in ST Microelectronics Application Note AN1060, “Flyback Converters with the L6561 PFC Controller,” by C. Adragna and G. Garravarik, January 2003, and ST Microelectronics Application Note AN1059, “Design Equations of High-Power-Factor Flyback Converters based on the L6561,” by Claudio Adragna, September 2003, each of which is available at http://www.st.com and is incorporated herein by reference. Differences between the L6561 and L6562 controllers are discussed in ST Microelectronics Application Note AN1757, “Switching from the L6561 to the L6562,” by Luca Salati, April 2004, also available at http://www.st.com and incorporated herein by reference. For purposes of the present disclosure, these two controllers may be discussed as having similar functionality.

In the embodiment shown in FIG. 7 and some other embodiments, the secondary winding 208c of the transformer 204c is not electrically coupled to the primary winding 206c of the transformer 204c, e.g. there is no common ground electrical path for the windings. In some embodiments, however, the secondary winding 208c may be capacitively coupled to the feedback winding 210c to improve EMI filtering, but no common ground electrical path for the windings results from this coupling. In some embodiments an optically isolated feedback is provided from the open circuit protection circuit 218c to the power factor controller circuit 216c through the optical isolation coupling 224c. The optional open circuit protection circuit 218c may be configured to provide an output for shutting down or prohibiting operation of the power factor controller circuit 216c upon the occurrence of an open circuit in the load (e.g., the LED-based light source 106a shown in FIG. 6). For example, if the LED-based light source 106a ceases conducting current from the secondary winding 208c, e.g. if the load is not connected or malfunctions, a dangerous over-voltage condition on the terminals of the transformer 204c may arise. In the illustrated embodiment, the open circuit protection circuit 218c is coupled between the output stage 214c and the power factor controller circuit 216c. In embodiments including an L6561 or L6562 power factor controller, for example, the open circuit protection circuit 218c may be coupled to the zero current detection (ZCD) input of the power factor controller for shutting the controller down if an open circuit exists at the load. The optical isolation coupling 224c provides protective electrical isolation between the primary winding 206c side of the transformer 204c, with potentially high voltages, and the secondary winding 208c side. In some embodiments, the open circuit protection circuit 218c may provide protection that complies with Underwriters Laboratory (UL) class 2 requirements.

In some embodiments, the supply voltage circuit 220c may establish a DC supply voltage V_{supply} to the power factor controller circuit 216c. In the illustrated embodiment, the supply voltage circuit 220c is coupled between the unregulated DC voltage, the feedback winding 210c, and the power factor controller circuit 216c. The supply voltage circuit 220c may be coupled to the power supply input (e.g. the Vcc in the L6561 or L6561) of the power factor controller circuit 216c and may provide the DC supply voltage V_{supply} to the power factor controller circuit 216c at the high end of a nominal supply voltage operating range of the power factor controller circuit 216c. In particular, a power factor controller circuit 216c has power supply input operational range between a nominal low operating voltage V_{low} and a nominal high operating voltage V_{high}. The nominal low operating voltage V_{low} is the voltage below which the power factor controller circuit 216c stops providing pulsed output to the switch 212c and the nominal high operating voltage V_{high} is a voltage above which damage to the power factor controller circuit 216c may occur. As used herein, use of the term “nominal” or “nominally” when referring to an amount means a designated or theoretical amount that may vary from the actual amount. The values of the nominal low operating voltage V_{low} and the nominal high V_{high} operating voltage may be determined empirically, or, in the case of an integrated circuit power factor controller circuit 216c, through use of manufacturer specifications. For an integrated circuit power factor controller, such as the L6561 or L6562 power factor controller, for example, the manufacturer sets the nominal high operating voltage V_{high}. The nominal low operating voltage V_{low} for an integrated circuit power factor controller circuit 216c is also typically specified by the manufacture as the nominal voltage at which the power factor controller circuit 216c will turn off or stop providing an output after it has been operational. In the specific example of a L6562 power factor controller circuit 216c, in the manufacturer data sheet the manufacturer identifies the nominal high operating voltage V_{high} as 22 VDC and the nominal low operating voltage V_{low} (at which the controller turns off) as 9.5 VDC.

The voltage reference circuit 220c may be configured to provide a voltage supply input V_{supply} to the power supply input of the power factor controller circuit 216c, such that V_{supply} is between the nominal high operating voltage V_{high} and the average of the nominal high operating voltage V_{high} and the nominal low V_{low} operating voltage:

V_{high}>V_{supply}≧(V_{low}+V_{high})/2

This places the value of V_{supply} at the high end of the nominal supply voltage operating range of the power factor controller circuit 216c. In the specific example of the L6562 power factor controller circuit having a V_{high} of 22 VDC and a V_{low} of 9.5 VDC, V_{supply} would be less than 22 VDC but greater than or equal to 15.75 VDC. When a dimmer, such as the dimmer circuit 104a shown in FIG. 6 is used in conjunction with the LED driver circuit 102a, the supply voltage circuit 220c may be configured to maintain the value of V_{supply} at the high end of the nominal supply voltage operating range of the power factor controller circuit 216c even during the dead time associated with the lowest dimmer setting of the dimmer circuit 104a. This allows for high power factor and low THD for all dimmer settings.

The supply voltage circuit 220c and the open circuit protection circuit 218c are described herein as being useful in connection with a solid state light source driver circuit wherein the secondary winding 208c is electrically isolated from the primary winding 206c but may be capacitively coupled to the feedback winding 210c and feedback may be optically coupled from the secondary winding 208c to the power factor controller circuit 216c. Those of ordinary skill in the art will recognize, however, that these circuits 218c, 220c may be provided in a wide variety of driver configurations. For example, these circuits may be included in a driver configuration including different transformer or feedback configurations.

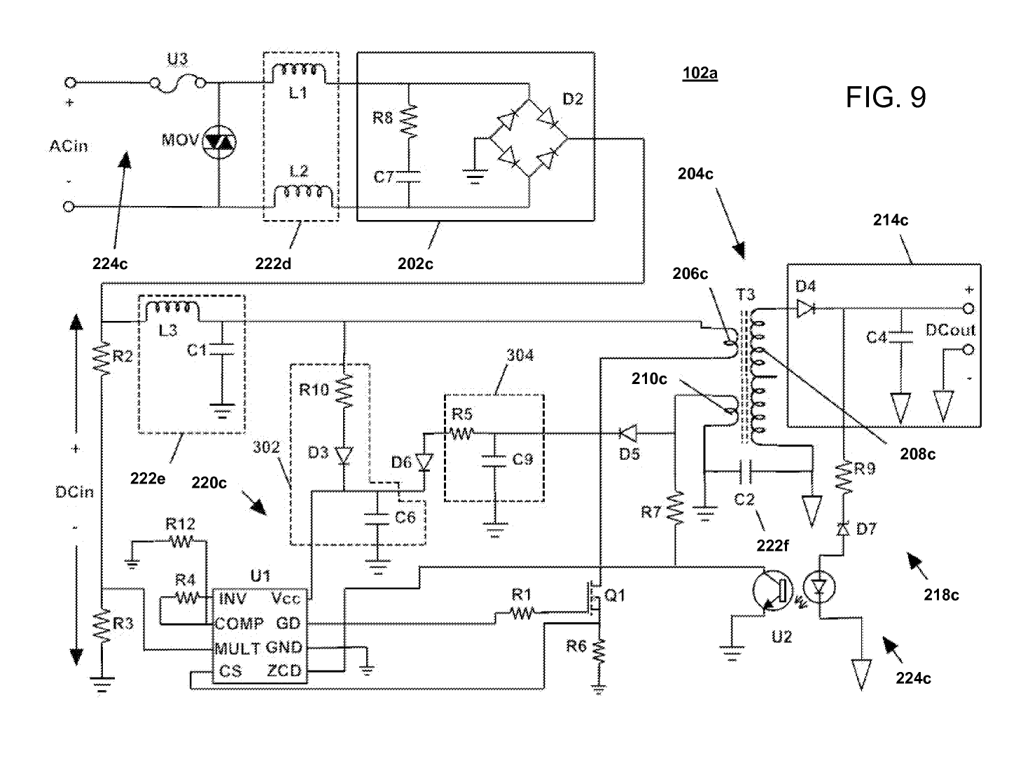

FIG. 8 is a block diagram that conceptually illustrates the functionality of an embodiment of a supply voltage circuit 220c. As shown, the supply voltage circuit 220c includes a first energy storage circuit 302 and a second energy storage circuit 304. The first energy storage circuit 302 is coupled to the unregulated DC voltage, which charges a first energy storage element 310 therein. The voltage across the first energy storage element 310 may be coupled the power factor controller circuit 216c as the V_{supply} input. The second energy storage circuit 304 is coupled to the feedback winding 210c of the transformer 204c. During the period when the switch 212c is open and energy is transferred from the primary winding 206c to the secondary winding 208c and the feedback winding 210c, current from the feedback winding 210c charges a second energy storage element 312 in the second energy storage circuit 304 and also charges the first energy storage element 310. This combination of the first energy storage circuit 302 and the second energy storage circuit 304 allows the supply voltage circuit 220c to provide a consistent and stable DC supply input to the power factor controller circuit 216c that is at the high end of the nominal supply voltage operating range of the power factor controller circuit 216c even during the dead time associated with the lowest dimmer setting of a dimmer, such as but not limited to the dimmer circuit 104a shown in FIG. 6.

The supply voltage circuit 220c provides a supply voltage at the high end of the nominal supply voltage operating range of the power factor controller circuit 216c. Thus, the supply voltage circuit 220c may include capacitors of reduced capacitance value while still maintaining sufficient energy storage capability. This is possible because the energy storage of a capacitor is proportional to CV², where C is the value of capacitance and V is the voltage across the capacitor. Such a configuration may be particularly useful when the system is implemented with a dimmer, such as but not limited to a phased controlled dimmer circuit, so that the supply voltage circuit 220c can maintain adequate voltage supply to the power factor controller circuit 216c during dimming, and thus avoid flicker in the LED-based light source 106a. The ability to reduce capacitor size is also advantageous since larger capacitors (e.g., electrolytic capacitors) are expensive, prone to failure, and require increased time to charge, which may delay the turn-on time of the LED-based light source 106a. The supply voltage circuit 220c may preferably be implemented without the use of Zener diodes to regulate the supply voltage of the power factor controller circuit 216c since the reduced capacitor sizes of embodiments may not have enough energy storage to avoid flicker in the LED-based light source 106a when the Zener diodes reach cut-off voltage.

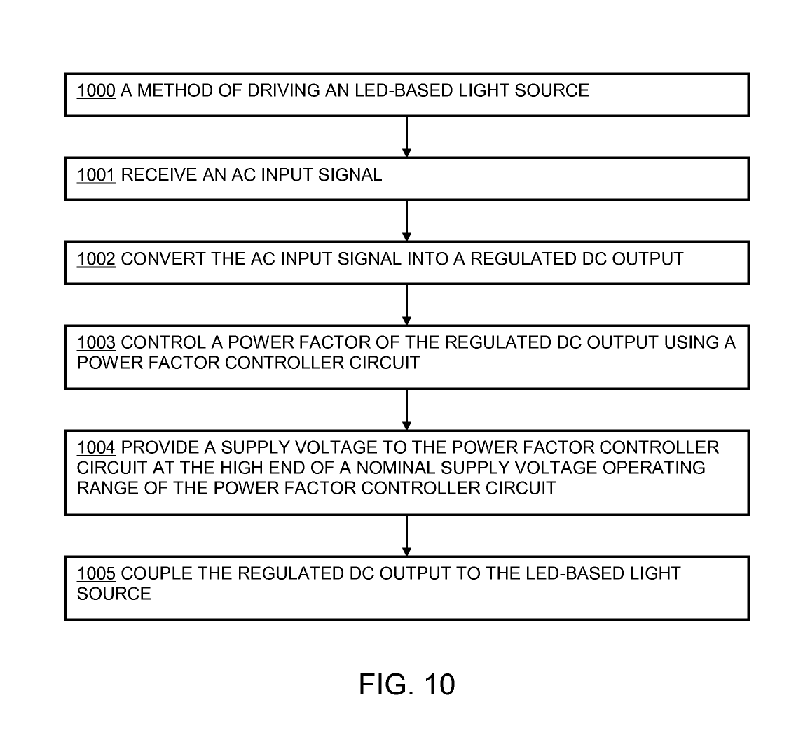

FIG. 9 is a schematic diagram illustrating an embodiment of an LED driver circuit 102a, which includes an input voltage surge protection circuit 224c, an EMI filter 222d, a rectifier circuit 202c, a transformer 204c including a primary winding 206c, a secondary winding 208c, and a feedback winding 210c, a switch Q1 212c for coupling the output of the rectifier circuit 202c to the primary winding of the transformer 206c, an output stage 214c coupled to the secondary winding 208c of the transformer 204c, a power factor controller circuit 216c, an open circuit protection circuit 218c, an optical isolation coupling 224c, and a supply voltage circuit 220c including a first energy storage circuit 302 and a second energy storage circuit 304. The power factor controller circuit 216c includes a L6562 integrated circuit power factor controller U1, the operation of which is known and described in ST Microelectronics Application Note AN1757, referred to above. Those of ordinary skill in the art will recognize, however, that other known power factor controllers may be used in place of the L6562 controller shown in the embodiment of FIG. 9.

In operation, the AC input to the circuit ACᵢₙ is coupled to the rectifier circuit 202c through the surge protection circuit 224c and the EMI filter 222d. The surge protection circuit 224c includes a fuse U3 and a metal oxide varistor (MOV) which protect the LED driver circuit 102 from input voltage surges. The EMI filter 222d, including inductors L1 and L2, filters EMI noise generated in the circuit. The rectifier circuit 202c includes a known bridge rectifier. The rectifier circuit 202c rectifies the AC input to provide a rectified unregulated DC voltage DCᵢₙ. The output of the rectifier DCᵢₙ is coupled to an inductor L3 and a capacitor C1 of an EMI filter 222e, which further filters EMI noise generated in the circuit. A third EMI filter 222f includes a capacitor C2, which couples the feedback winding ground to the secondary winding ground for additional EMI noise filtering. The values of the inductors L1, L2, and L3, and the capacitors C1, C2 and C7 may be chosen to adjust the phase angle between the input voltage and input current to achieve low THD.

The primary winding 206c of the transformer 204c is coupled between the output of the rectifier circuit 202c and the drain of the switch Q1 212c so that when the switch Q1 212c is conducting, i.e. the switch Q1 212c is closed, current flows from the output of the rectifier circuit 202c through the primary winding 206c to energize the primary winding 206c, but when the switch Q1 212c is not conducting, i.e. the switch Q1 212c is open, essentially no current flows through the primary winding 206c. In general, when the switch Q1 212c is closed, the windings of the transformer 204c are energized, and when the switch Q1 212c opens, the polarity of the voltage across the secondary winding 208c and the feedback winding 210c reverses to forward bias diodes D4 and D5. When the diode D4 is forward biased, energy from the secondary winding 208c charges a capacitor C4, which is configured to discharge through the load when the switch Q1 212c is open.

In general, the power factor controller U1 uses a voltage representative of the output of the rectifier circuit 202c DCᵢₙ as a reference to control the level at which the power factor controller circuit 216c switches the switch Q1 212c on and off using the gate drive GD output coupled to the gate of the switch Q1 212c through a resistor R1. This feature allows a very high power factor driver. The switching frequency is determined by feedback from the primary 206c winding and the feedback winding 210c. In particular, a portion of the DCᵢₙ voltage is coupled to a multiplier input MULT of the power factor controller circuit 216c to provide a signal to the power factor controller U1 representative of the unregulated DC voltage DCᵢₙ. The MULT input is coupled between resistors R2 and R3. Selection of the value of the resistor R3 allows for a tradeoff between ripple and power factor correction in the output voltage DCₒᵤₜ established by the power factor controller U1. The source of the switch Q1 212c is coupled to a current sense CS input of the power factor controller U1 and to a ground through a resistor R6. The current through the resistor R6 thus provides a signal to the power factor controller U1 representative of the current through the primary winding 206c. The feedback winding 210c of the transformer 204c is coupled through a resistor R7 to a ZCD input of the power factor controller U1 to provide a signal to the power factor controller U1 representative of the current through the feedback winding 210c. In response to the MULT, ZCD and CS inputs, the power factor controller U1 provides a variable frequency gate drive GD output to the switch Q1 212c for driving the load with a high power factor.

Supply voltage is supplied to the power factor controller U1 supply voltage input Vcc through the supply voltage circuit 220c. When there is no starting pulse at the gate of the switch Q1 212c, no current is provided from the rectifier circuit 202c output to energize the windings of the transformer 204c. Once the voltage on Vcc reaches its minimum value, the gate drive output GD of the power factor controller U1 provides a starting pulse to the gate of the switch Q1 212c through the resistor R1 to close the switch Q1 212c so that at least a portion of the output of the rectifier circuit 202c is provided across the primary winding 206c to energize the windings of the transformer 204c. The drain current in the switch Q1 212c begins to ramp up at a rate determined by the primary inductances of the transformer 204c. This current produces a voltage across the resistor R6, which is representative of the current through the primary winding 206c. This current is fed into the current sense CS input of the power factor controller U1. The power factor controller U1 compares this voltage to the voltage on the multiplier input MULT, which is set by the resistor R2 and R3, and the voltage on an inverting input INV, which is set by resistors R4 and R12, to limit the current through the switch Q1 212c. When the voltage conditions are met according to the switching characteristics set by the power factor controller U1, the drive to the switch Q1 212c is removed. This causes the voltage across the primary winding 206c and the secondary winding 208c of the transformer 204c to reverse. The energy stored in the transformer 204c is then transferred to the output via the diode D4. The capacitor C4 reduces voltage swing on the output and provides noise reduction to the open circuit protection circuit 218c. During this same time interval, the transformer 204c provides a voltage on the feedback winding 210c that forward biases the diode D5 to provide current to the supply voltage circuit 220c.

In FIG. 9 as shown, the supply voltage circuit 220c includes a first energy storage circuit 302 and a second energy storage circuit 304. The first energy storage circuit 302 includes a resistor R10, a diode D3 and a first energy storage element, a capacitor C6. The second energy storage circuit 304 includes a second energy storage element, a capacitor C9, and a resistor R5, and is coupled to the feedback winding 210c through the diode D5. The first energy storage element C6 is coupled in parallel with the second energy storage element C9 through the diode D6. In operation, the unregulated DC voltage charges the capacitor C6 through the resistor R10 and the diode D3. The voltage across the capacitor C6 is coupled to the power supply input V_{supply} to the power factor controller U1 power supply input V_{cc}. When the diode D5 is forward-biased by current through the feedback winding 210c, a current is established through the resistor R5, which charges both of the capacitors C9 and C6. The capacitors C6 and C9 thus both provide supply voltage to the Vcc input of the power factor controller U1.

After all the energy is removed from the transformer 204c, the voltage on the feedback winding 210c drops to zero. This negative transition on the zero current detection input ZCD of the power factor controller U1 instructs it to start a new cycle. After several cycles, the supply voltage output of the supply voltage circuit 220c reaches an operating level determined by the charge on the capacitors C6 and C9, which remains high enough to power the power factor controller U1 including time periods when the LED-based driver circuit 102a is operated by a dimmer, even during the dead time associated with the lowest dimmer setting.

The open circuit protection circuit 218c includes resistors R9 and R7, and a Zener diode D7. The open circuit protection circuit 218c is coupled to the power factor controller U1 by the optical isolation coupling 224c, which in FIG. 9 is an optically isolated switch U2. The optically isolated switch U2 is optically coupled to the secondary winding 208c through the resistor R9 and the Zener diode D7, and is also coupled to the ZCD input of the power factor controller U1. When the LED-based driver circuit 102a is driving a load such as the LED-based light source 106a shown in FIG. 6, the optically isolated switch U2 is in a non-conducting (open) state. When an open circuit occurs at the load, e.g. due to failure of the LED-based light source 106a in an open state, the open circuit voltage of the output stage 214c is the breakdown voltage of the Zener diode D7 plus the forward voltage of the optically isolated switch U2. The optically isolated switch U2 enters a conducing state (closes) once the Zener diode D7 begins conducting. When the optically isolated switch U2 closes, the ZCD input of the power factor controller U1 is clamped to ground, which shuts down the power factor controller U1 and opens the switch Q1 212c. The open circuit protection circuit 218c thus disables the current supply to the transformer 204c to provide protection against dangerous voltages occurring in the circuit due, for example, to disconnection or malfunction of the load.

A driver circuit according to embodiments described herein may be configured for operation with a variety of input voltages based on appropriate selection of various circuit components thereof. Table 2 below identifies one example of circuit components useful in configuring the embodiment illustrated in FIG. 9 for operation with a 120V RMs/60 Hz AC input signal (resistor values in ohms):

TABLE 2

| | Descriptor/ |
|---|---|
| Component | Value |
| ACin | 120 VAC/ |
| | 60 Hz |
| C1 | 47 nf |
| C2 | 3.3 nF |
| C4 | 1 uF |
| C6 | 22 uf |
| C7 | 100 nF |
| C9 | 22 uF |
| D2 | DF10S |
| D3 | RS1M |
| D4 | RS3GB |
| D5 | RS1M |
| D6 | 1N4148 |
| D7 | BZV55 |
| DCout | LED |
| | connection |
| L1 | 1 mH |
| L2 | 4.7 mH |
| L3 | 2 mH |
| MOV | P1402 |
| Q1 | K4A60DA |
| R1 | 68 |
| R2 | 1.1M |
| R3 | 8.2k |
| R4 | 120k |
| R5 | 120 |
| R6 | 2 |
| R7 | 47k |
| R8 | 147 |
| R9 | 110 |
| R10 | 220k |
| R12 | 300k |
| T3 | LP = 66uH |
| U1 | L6562 |
| U2 | TLP181 |
| U3 | C1Q5A |

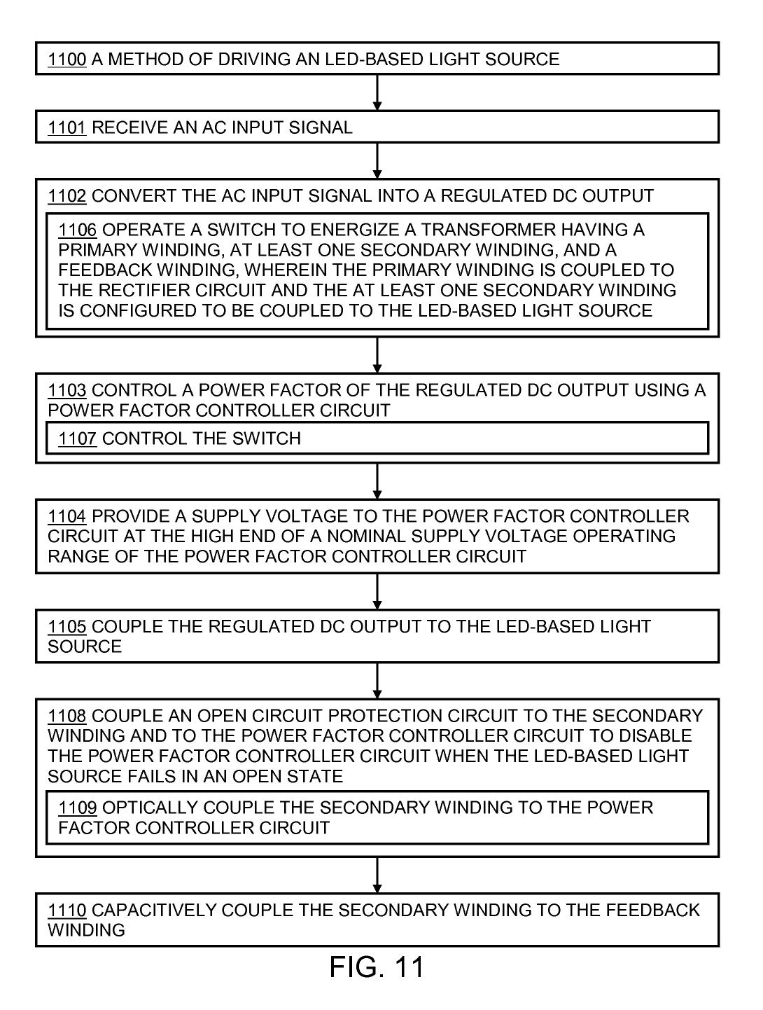

FIGS. 10 and 11 are block flow diagrams of methods 1000 and 1100 of driving an LED-based light source according to embodiments described herein. The illustrated block flow diagrams may be shown and described as including a particular sequence of steps. It is to be understood, however, that the sequence of steps merely provides an example of how the general functionality described herein can be implemented. The steps do not have to be executed in the order presented unless otherwise indicated.

In the methods 1000 and 1100 shown in FIGS. 10 and 11, an AC input signal is received, step 1001/1101. The AC input signal is converted into a regulated DC output, step 1002/1102. In some embodiments, a switch is operated, step 1106, to energize a transformer having a primary winding, at least one secondary winding, and a feedback winding, wherein the primary winding is coupled to the rectifier circuit and the at least one secondary winding is configured to be coupled to the LED-based light source. A power factor of the regulated DC output is controlled, step 1003/1103, using a power factor controller circuit. In some embodiments, this is achieved by controlling the switch, step 1107. A supply voltage is provided, step 1004/1104, to the power factor controller circuit at the high end of a nominal supply voltage operating range of the power factor controller circuit. The regulated DC output is coupled to the LED-based light source, step 1005/1105. In some embodiments, an open circuit protection circuit is coupled to the secondary winding and to the power factor controller circuit to disable the power factor controller circuit when the LED-based light source fails in an open state, step 1108, which may additionally or alternatively include optically coupling the secondary winding to the power factor controller circuit, step 1109. In some embodiments, the secondary winding may be capacitively coupled to the feedback winding, step 610.

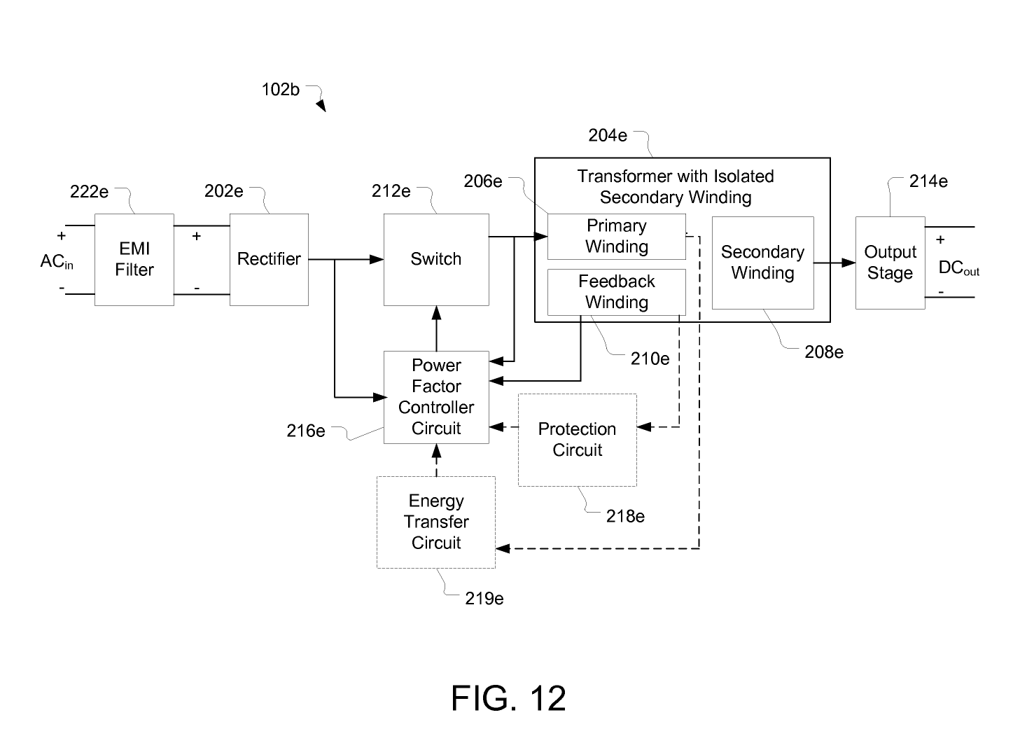

Embodiments shown and described herein in relation to FIGS. 12-14 improve performance (higher lumens, higher lumens per watt) for devices including solid state light sources, by lowering cost and weight and number of components used, improving thermal management, and improving key electrical performance characteristics, such as but not limited to dimming, EMI, power factor, THD, and isolated output.

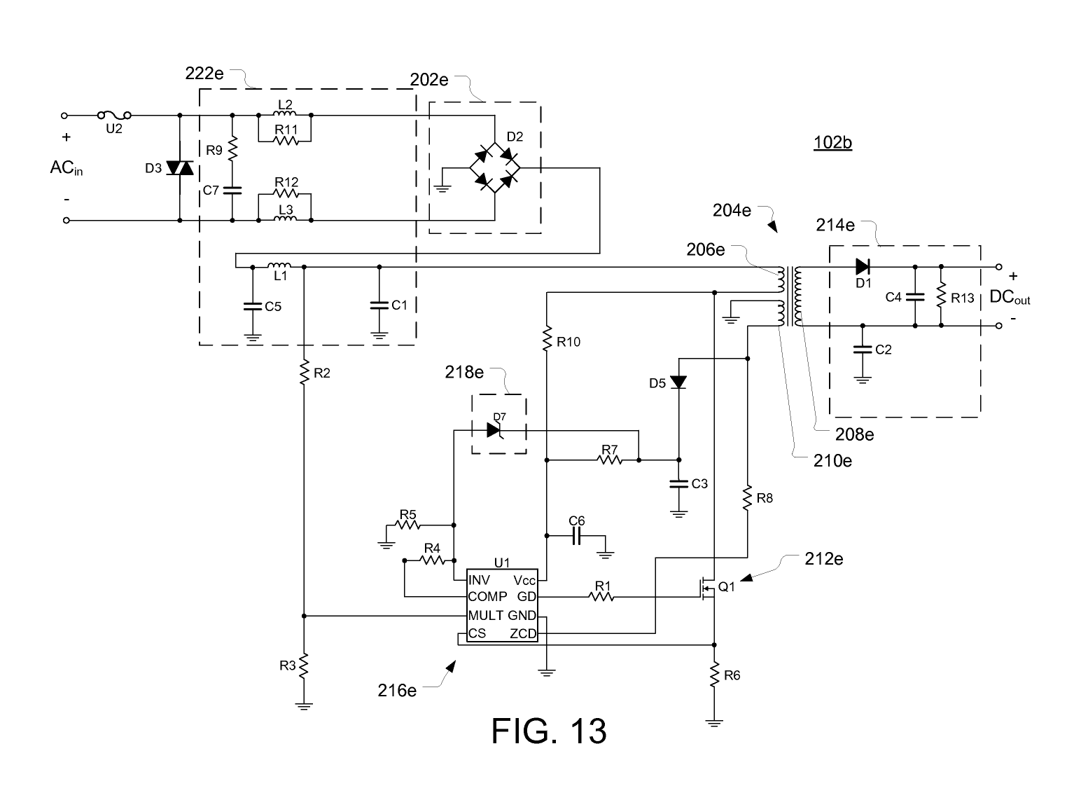

FIG. 12 is a block diagram of a solid state light source driver circuit 102b that includes an EMI filter 222e, a rectifier 202e, a transformer 204e including a primary winding 206e, a secondary winding 208e, and a feedback winding 210e, a switch 212e for coupling the output of the rectifier 202e to the primary winding 206e of the transformer 204e, an output stage 214e coupled to a secondary winding 208e of the transformer, and a power factor controller circuit 216e. In some embodiments, the driver circuit 102b may also include a protection circuit 218e and/or an energy transfer circuit 219e. Similar to the ballast circuit 102 shown in FIG. 2 and the driver circuit 102a shown in FIG. 7, an AC input voltage ACᵢₙ may be coupled to the rectifier circuit 202e via the EMI filter 222e, either directly or through a dimmer circuit (not shown in FIG. 12). The EMI filter 222e removes noise for the AC input voltage ACᵢₙ, is described in greater detail below with regards to FIG. 13. The rectifier circuit 202e is configured to rectify the AC input voltage ACᵢₙ to provide a filtered unregulated DC output voltage, i.e. a DC output voltage that follows instantaneous variations in the AC input voltage. Of course, any known rectifier circuit may be, and in some embodiments is, used. The output of the rectifier 202e, after in some embodiments passing through further elements of the EMI filter 222e, is coupled to the primary winding 206e of the transformer 204e through the switch 212e under the control of the power factor controller circuit 216e. The switch 212e and the controller circuit 216e operate similarly to the switch 212 and the power factor controller circuit 216 of FIG. 2.

The power factor controller circuit 216e may include a known power factor controller (not shown) configured to provide an output to the switch 212e for controlling the switch 212e in response to a signal representative of current through the primary winding 206e, a second signal representative of current through the feedback winding 210e, and a third signal representative of the unregulated DC voltage, with no feedback signal coupled from the secondary winding 208e to the controller. The output from the power controller may control the switch so that the current to the LED-based light source 106 has a waveform that substantially matches and is in phase with the output of the rectifier 202e, thereby providing high power factor. As in FIG. 2, the power factor controller circuit 216e may be, and in some embodiments is, one of model number L6561 and L6562 controllers presently available from ST Microelectronics of Sunnyvale, Calif. The L6561 and L6562 controllers may, for example, be employed as a controller in a “flyback” DC-DC converter implementation. The secondary winding 208e of the transformer 204a is not electrically coupled in any way to the primary winding 206e or to the feedback winding 210e, e.g. there is no common ground electrical path for the windings and there is no feedback path coupled from the secondary winding 208e to the power factor controller circuit 216e or any other element on the primary winding side of the driver circuit 102b. The power factor controller circuit 216e operates using signals coupled thereto from the output of the rectifier 202e, and the primary winding 206e and the feedback winding 210e, but no feedback signal is coupled, e.g. electrically or optically, from the secondary winding 208e to the power factor controller circuit 216e. This provides complete protective isolation for the high voltages on the primary winding side of the transformer 204e and the secondary side of the transformer 204e. In addition, by not requiring feedback from the secondary winding 208e, the overall size and complexity of the driver circuit 102b is reduced compared to configurations wherein, for example, optically isolated feedback is provided from the secondary winding 208e to the controller.

The optional protection circuit 218e, located between the feedback winding 210e and the power factor controller circuit 216e, is provided to shut down or prohibit operation of the power factor controller circuit 216e upon the occurrence of an open circuit condition. In some embodiments, the optional protection circuit 218e is a Zener diode, which is coupled to an INV port of an L6561 or L6562 power factor controller circuit and, via a resistor, to a Vcc port of the same. In some embodiments, an optional energy transfer circuit 219e is coupled between the primary winding 206e of the transformer 204e and the power factor controller circuit 216e. The energy transfer circuit 219e helps to transfer energy away from the switch 212e and to the power factor controller circuit 216e, improving efficiency in the driver circuit 102b.

FIG. 13 shows the driver circuit 102b in circuit diagram form, including the optional protection circuit 218e but not the optional energy transfer circuit 219e. In FIG. 13, an AC input voltage ACᵢₙ is applied to the EMI filter 222e after passing through a fuse U2 and a metal oxide varister D3, which together protect the driver circuit 102b from surges and high voltage transients that may occur at the input. The EMI filter 222e includes an inductor L1, an inductor L2, an inductor L3, a resistor R9, a resistor R11, a resistor R12, a capacitor C1, a capacitor C5, and a capacitor C7. After passing through the fuse U2 and the metal oxide varister D3, the AC input voltage ACᵢₙ goes through the series combination of the resistor R9 and the capacitor C7, connected in parallel across the input. The resistor R9 and the capacitor C7, particularly in embodiments where a triac dimmer is modifying the AC input voltage ACᵢₙ, dampens an LC value associated with the triac dimmer. This allows the triac dimmer to properly interface with a solid state light source load present at the output stage 214e, and particularly in embodiments where the triac dimmer is connected to more than one lamp assembly or other device including two or more driver circuits 102b and corresponding solid state light sources connected thereto. The input signal next passes through two parallel combinations of an inductor and a resistor, namely the inductor L2 and the resistor R11 on the positive side, and the inductor L3 and the resistor R12 on the negative side. The input voltage then reaches the rectifier circuit 202e, which includes a known full wave bridge rectifier D2 that generates the bulk voltage for the driver circuit 102b. The unregulated but rectified DC voltage is then filtered again by the inductor L1 and the capacitors C5 and C1, with one capacitor on either side of the inductor L1 and connected also to ground. The filtered unregulated DC voltage is provided to the transformer 204e, and more particularly to the primary winding 206e. The remainder of the primary side of the driver circuit 102b is similar to that of the ballast circuit 102 of FIG. 2. That is, a resistor divider formed by resistors R2 and R3, located between the inductor L1 and the capacitor C1, generates voltage used by multiplier circuit internal to the L6562 controller U1 that is the power factor controller circuit 216e for power factor correction. The controller U1 receives its voltage for start-up from a resistor R10, which is connected between the Vcc input of the controller U1 and the primary winding 206e of the transformer 204e. A capacitor C6 is also connected to the Vcc input of the controller U1, to filter and store energy to operate the controller U1 during the valley of the filtered rectified input voltage. A resistor R4 is connected between the INV and COMP inputs of the controller U1. A resistor R5 is also connected to the INV input of the controller U1, which is additionally coupled to the optional protection circuit 218e, shown in FIG. 13 as a Zener diode D7. The Zener diode D7 turns off the controller U1 in the event of an open circuit situation, clamping the output voltage to a safe level, such as but not limited to the level required by UL safety standards. The GD (gate drive) output of the controller U1 is connected to a gate of the switch Q1 212e, as described in similar embodiments above. A diode D5 and a resistor R7 are connected in series between the Vcc input of the controller U1 and the feedback winding 210e. The resistor R7 limits power dissipation in the controller U1 under high line conditions, but must provide enough current to the controller U1 when a dimmer or dimmers is used, particularly at low dimming angles. A capacitor C3 is connected between the diode D5 and the resistor R7 and ground, to also filter and store energy to operate the controller U1 during the valley of the filtered rectified input voltage. After the controller U1 begins to oscillate, the diode D5 rectifies the voltage from the feedback winding 210e of the transformer 204e. The switch Q1 212e, in some embodiments, is a power transistor and has a high voltage rating, to handle the flyback voltage at its drain terminal. The transformer 204e must be designed to minimize the leakage inductance to reduce the flyback voltage, since the driver circuit 102b does not have a damping network. The remaining components on the primary side of the driver circuit 102b, including a resistor R6 and a resistor R8, function similar to their respective counterparts in the ballast circuit 102 shown in FIG. 2.

On the secondary side of the driver circuit 102b, the output stage 214e includes a diode D1 connected to the secondary winding 208e and in series with a capacitor C4, which is also connected to the secondary winding 208e. A resistor R13 is in parallel with the capacitor C4, which also places it in parallel with the output, at which the output voltage DCₒᵤₜ is provided to a load (e.g., one or more solid state light sources). A capacitor C2 is connected in series between the capacitor C4 and ground. The capacitor C2 is used to pass noise on the output circuit to ground, which improves conducted and radiated EMI margins of the driver circuit 102b. The capacitor C4 reduces the ripple current in the load (i.e., the one or more solid state light source(s)) connected to the output stage 214e, while the resistor R13 keeps the voltage within bounds during an open circuit situation.

A driver circuit according to embodiments described herein may be configured for operation with a variety of input voltages based on appropriate selection of various circuit components thereof. Table 3 below identifies one example of circuit components useful in configuring the embodiment illustrated in FIG. 13 for operation with a 120V RMs/60 Hz AC input signal (resistor values in ohms):

TABLE 3

| | Descriptor/ |
|---|---|
| Component | Value |
| ACin | 120 VAC/ |
| | 60 Hz |
| C1 | 33 nf |
| C2 | 3.3 nF |
| C3 | 47 uF |
| C4 | 330 uf |
| C5 | 18 nF |
| C6 | 1 uF |
| C7 | 33 nF |
| D1 | |
| D2 | DF10S |
| D5 | RS1M |
| D7 | BZV55 |
| DCout | LED |
| | connection |
| L1 | 6.8 mH |
| L2 | 6.8 mH |
| L3 | 6.8 mH |
| D3 | P1402 |
| Q1 | K4A60DA |
| R1 | 330 |
| R2 | 1.1M |
| R3 | 8.2k |
| R4 | 20k |
| R5 | 20k |
| R6 | 2 |
| R7 | 150 |
| R8 | 47k |
| R9 | 24k |
| R10 | 220k |
| R11 | 4.7k |
| R12 | 4.7k |
| R13 | 33k |
| T | LP = 66 uH |
| U1 | L6562 |
| U2 | 2 Amps |

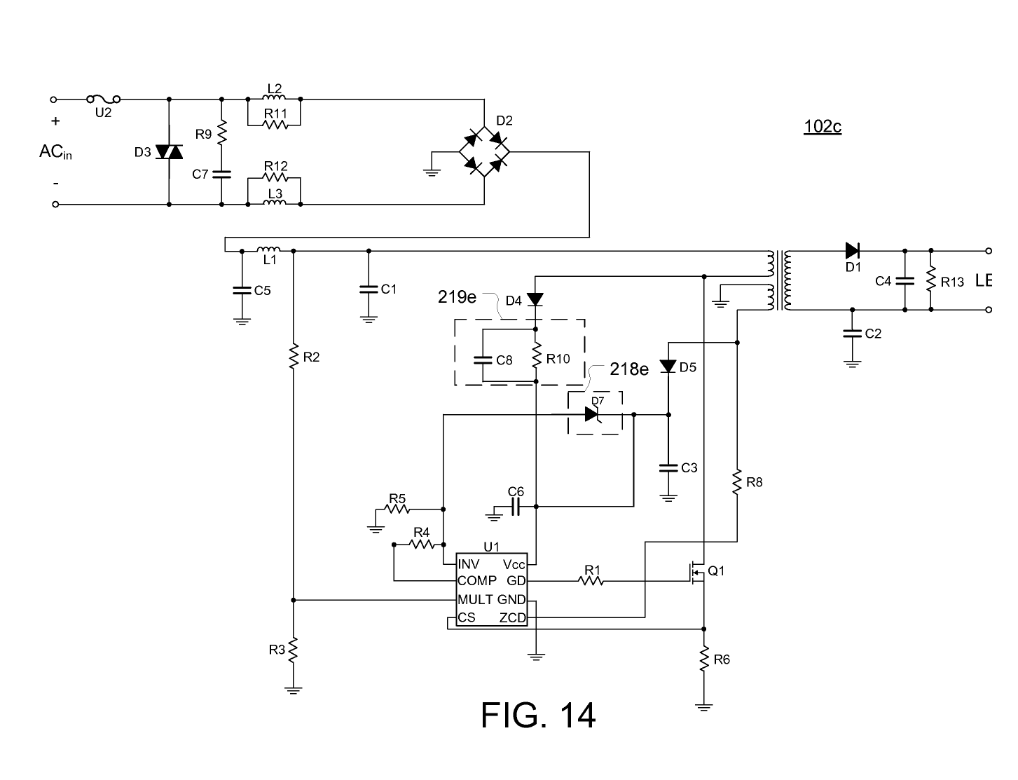

FIG. 14 is a circuit diagram of an alternate embodiment 102c of the driver circuit 102b shown in FIG. 13. In FIG. 14, the input stage (i.e., the EMI filter 222e and the rectifier 202e) and the output stage 214e are the same as in FIG. 13. The transformer 204e, the resistors R2, R3, R4, R5, R6, and R8, the switch Q1 212e, and the capacitor C6 are also the same as in FIG. 13. Where FIG. 14 differs is in the addition of the optional energy transfer circuit 219e and the location of the optional protection circuit 218e. The optional energy transfer circuit 219e includes the resistor R10, which has a capacitor C8 (in some embodiments, having a value of 10 nF) in parallel with it, and is connected to the Vcc input of the controller U1. A diode D4 is connected between the resistor R10 and the primary winding 206e of the transformer 204e. The optional protection circuit 218e, again in the form of a Zener diode D7, is now between the optional energy transfer circuit 219e (and thus the Vcc input of the controller U1) and the diode D5. Thus, the resistor R7 is not present in the driver circuit 102c. Further, a cathode of the Zener diode D7 and a cathode of the diode D5 is connected to the capacitor C6. These connections result in energy being transferred from the switch Q1 212e to the controller U1, resulting in improved efficiency.

The methods and systems described herein are not limited to a particular hardware or software configuration, and may find applicability in many computing or processing environments. The methods and systems may be implemented in hardware or software, or a combination of hardware and software. The methods and systems may be implemented in one or more computer programs, where a computer program may be understood to include one or more processor executable instructions. The computer program(s) may execute on one or more programmable processors, and may be stored on one or more storage medium readable by the processor (including volatile and non-volatile memory and/or storage elements), one or more input devices, and/or one or more output devices. The processor thus may access one or more input devices to obtain input data, and may access one or more output devices to communicate output data. The input and/or output devices may include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) may be implemented using one or more high level procedural or object-oriented programming languages to communicate with a computer system; however, the program(s) may be implemented in assembly or machine language, if desired. The language may be compiled or interpreted.

As provided herein, the processor(s) may thus be embedded in one or more devices that may be operated independently or together in a networked environment, where the network may include, for example, a Local Area Network (LAN), wide area network (WAN), and/or may include an intranet and/or the internet and/or another network. The network(s) may be wired or wireless or a combination thereof and may use one or more communications protocols to facilitate communications between the different processors. The processors may be configured for distributed processing and may utilize, in some embodiments, a client-server model as needed. Accordingly, the methods and systems may utilize multiple processors and/or processor devices, and the processor instructions may be divided amongst such single- or multiple-processor/devices.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s) or smart cellphone(s), laptop(s), handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one, of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. A driver circuit for a solid state light source, comprising:
an input stage comprising a rectifier circuit and a filter circuit, wherein the input stage is configured to receive an AC input voltage, to filter the received AC input voltage, and to rectify the received AC input voltage so as to provide a filtered unregulated DC voltage;
a transformer having a primary winding coupled to the input stage, at least one secondary winding configured to be coupled to the solid state light source, and a feedback winding, the secondary winding being electrically isolated from the primary winding and the feedback winding with no electrical path between the primary winding and the secondary winding or the feedback winding and the secondary winding;
a switch, the switch being configured to close to couple a portion of the filtered unregulated DC voltage across the primary winding and the switch being configured to open to transfer energy from the primary winding to the secondary winding to provide a DC output voltage to drive the solid state light source; and
a power factor correction circuit configured to control the switch in response to a first signal representative of current through the primary winding, a second signal representative of current through the feedback winding, and a third signal representative of the filtered unregulated DC voltage, with no feedback signal coupled from the secondary winding to the power factor correction circuit.

2. The driver circuit of claim 1, wherein the filter circuit comprises a first filter stage, wherein the first filter stage comprises a series combination of a capacitor and a resistor in parallel across an input on which the AC input voltage is received, a first combination of an inductor in parallel with a resistor on a high side of the AC input voltage, and a second combination of an inductor in parallel with a resistor on a low side of the AC input voltage.

3. The driver circuit of claim 2, wherein the filter circuit is configured to reduce input capacitance at the input stage and to dampen an LC value associated with the input stage.

4. The driver circuit of claim 2, wherein the filter circuit further comprises a second filter stage, wherein the second filter stage comprises a first filter capacitor, a second filter capacitor, and an inductor.

5. The driver circuit of claim 4, wherein the first filter stage is configured to filter the AC input voltage and wherein the second filter stage is configured to filter the unregulated DC voltage provided by the rectifier circuit from the filtered AC input voltage.

6. The driver circuit of claim 1, further comprising a protection circuit coupled between the feedback winding of the transformer and the power factor correction circuit to disable the power factor correction circuit when an open circuit condition exists.

7. The driver circuit of claim 6, wherein the protection circuit comprises a Zener diode.

8. The driver circuit of claim 1, further comprising an energy transfer circuit coupled between the primary winding of the transformer and the power factor correction circuit to transfer energy away from the switch to the power factor controller circuit.

9. The driver circuit of claim 8, wherein the energy transfer circuit comprises a resistor in parallel with a capacitor.

10. A lamp assembly comprising:
a lamp housing;
a solid state light source disposed within the lamp housing; and
a driver circuit for the solid state light source, the driver circuit comprising:
an input stage comprising a rectifier circuit and a filter circuit, wherein the input stage is configured to receive an AC input voltage, to filter the received AC input voltage, and to rectify the received AC input voltage so as to provide a filtered unregulated DC voltage;
a transformer having a primary winding coupled to the input stage, at least one secondary winding configured to be coupled to the solid state light source, and a feedback winding, the secondary winding being electrically isolated from the primary winding and the feedback winding with no electrical path between the primary winding and the secondary winding or the feedback winding and the secondary winding;
a switch, the switch being configured to close to couple a portion of the filtered unregulated DC voltage across the primary winding and the switch being configured to open to transfer energy from the primary winding to the secondary winding to provide a DC output voltage to drive the solid state light source; and
a power factor correction circuit configured to control the switch in response to a first signal representative of current through the primary winding, a second signal representative of current through the feedback winding, and a third signal representative of the filtered unregulated DC voltage, with no feedback signal coupled from the secondary winding to the power factor correction circuit.

11. The lamp assembly of claim 10, wherein the filter circuit comprises a first filter stage, wherein the first filter stage comprises a series combination of a capacitor and a resistor in parallel across an input on which the AC input voltage is received, a first combination of an inductor in parallel with a resistor on a high side of the AC input voltage, and a second combination of an inductor in parallel with a resistor on a low side of the AC input voltage.

12. The lamp assembly of claim 11, wherein the filter circuit is configured to reduce input capacitance at the input stage and to dampen an LC value associated with the input stage.

13. The lamp assembly of claim 11, wherein the filter circuit further comprises a second filter stage, wherein the second filter stage comprises a first filter capacitor, a second filter capacitor, and an inductor.

14. The lamp assembly of claim 13, wherein the first filter stage is configured to filter the AC input voltage and wherein the second filter stage is configured to filter the unregulated DC voltage provided by the rectifier circuit from the filtered AC input voltage.

15. The lamp assembly of claim 10, wherein the driver circuit further comprises a protection circuit coupled between the feedback winding of the transformer and the power factor correction circuit to disable the power factor correction circuit when an open circuit condition exists.

16. The lamp assembly of claim 15, wherein the protection circuit comprises a Zener diode.

17. The lamp assembly of claim 10, wherein the driver circuit further comprises an energy transfer circuit coupled between the primary winding of the transformer and the power factor correction circuit to transfer energy away from the switch to the power factor controller circuit.

18. The lamp assembly of claim 17, wherein the energy transfer circuit comprises a resistor in parallel with a capacitor.
